(19) United States
(12) Patent Application Publication
(10) Pub. No.: US 2026/0228428 A1
(43) Pub. Date: Aug. 6, 2026

(54) INFORMATION PROCESSING APPARATUS AND INFORMATION PROCESSING METHOD

(71) Applicant: Naoyuki Shimizu, Kanagawa (JP)

(72) Inventor: Naoyuki Shimizu, Kanagawa (JP)

(73) Assignee: Ricoh Company, Ltd., Tokyo (JP)

(21) Appl. No.: 19/459,440

(22) Filed: Jan. 26, 2026

(30) Foreign Application Priority Data
Jan. 31, 2025 (JP) 2025-015217
Dec. 12, 2025 (JP) 2025-247819

(51) Int. Cl. G06F 40/242; G06F 16/3329; G06F 40/247

(52) U.S. Cl. CPC G06F 40/242; G06F 16/33295; G06F 40/247

(57) ABSTRACT

An information processing apparatus includes circuitry to receive an input of question data, refer to a term dictionary database storing term information in which each of a plurality of terms is associated with information indicating a meaning of a term to perform a determination process to determine whether the term is included in the question data, acquire the information indicating the meaning of the term from the term dictionary database, transmit a search request including the information indicating the meaning of the term included in the question data and the question data to a file database storing a file serving as an information source of answer data, generate a prompt requesting generation of the answer data based on the file, output the prompt to a large-scale language model, and output the answer data output by the large-scale language model based on the prompt.

### CROSS-REFERENCE TO RELATED APPLICATIONS

This patent application is based on and claims priority pursuant to 35 U.S.C. §119(a) to Japanese Patent Application Nos. 2025-015217, filed on Jan. 31, 2025 and 2025-247819, filed on Dec. 12, 2025, in the Japan Patent Office, the entire disclosure of which is hereby incorporated by reference herein.

### BACKGROUND

### Technical Field

The present disclosure relates to an information processing apparatus and an information processing method.

### Related Art

Currently, systems have been proposed that provide chatbot services. In such a chatbot service, input information such as questions and response information such as answers corresponding to the input information are registered and managed. When a question is received from a user of the system, the system analyzes the content of the question based on interpretation of an artificial intelligence (AI) and outputs an answer to the question.

### SUMMARY

The present disclosure described herein provides an information processing apparatus includes circuitry to receive an input of question data from a user via a terminal apparatus, refer to a term dictionary database to perform a determination process to determine whether a term is included in the question data, the term dictionary database storing term information in which each of a plurality of terms is associated with information indicating a meaning of the term, acquire, in a case that it is determined that the term is included in the question data, the information indicating the meaning of the term from the term dictionary database, transmit a search request to a file database, the search request including the information indicating the meaning of the term included in the question data and the question data, the file database storing a file serving as an information source of answer data, generate a prompt requesting generation of the answer data based on the file identified by searching the file database according to the search request, output the prompt to a large-scale language model, and output the answer data output by the large-scale language model based on the prompt to the terminal apparatus.

The present disclosure described herein further provides an information processing apparatus including circuitry to transmit, to a terminal apparatus, screen information for displaying a workflow creation screen for creating a workflow according to an input from a user via the terminal apparatus, create, according to the input to the workflow creation screen displayed on the terminal apparatus, the workflow defining contents of processes, and execute the workflow. The workflow includes a process to receive an input of question data, a process to refer to a term dictionary database to perform a determination process to determine whether a term is included in the question data, the term dictionary database storing term information in which the term is associated with information indicating a meaning of the term, a process to acquire, in a case that it is determined that the term is included in the question data, the information indicating the meaning of the term, a process to transmit a search request to a database, the search request including the information indicating the meaning of the term included in the question data and the question data, the database storing a file serving as an information source of answer data to the question data, a process to generate a prompt requesting generation of the answer data based on the file identified by searching the database according to the search request, a process to output the prompt to a large-scale language model, a process to acquire response data output by the large-scale language model based on the prompt, and a process to output the response data as the answer data.

The present disclosure described herein further provides an information processing method performed by an information processing apparatus, including receiving an input of question data, referring to a term dictionary database to perform a determination process to determine whether a term is included in the question data, the term dictionary database storing term information in which each of a plurality of terms is associated with information indicating a meaning of the term, acquiring, in a case that it is determined that the term is included in the question data, the information indicating the meaning of the term from the term dictionary database, transmitting a search request to a file database, the search request including the information indicating the meaning of the term included in the question data and the question data, the file database storing a file serving as an information source of answer data, generating a prompt requesting generation of the answer data based on the file identified by searching the file database according to the search request, outputting the prompt to a large-scale language model, and outputting the answer data output by the large-scale language model based on the prompt to a terminal apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of a chat system according to a first embodiment;

FIG. 2 is a block diagram illustrating a hardware configuration of an information processing apparatus;

FIG. 3 is a block diagram illustrating a hardware configuration of a terminal apparatus;

FIG. 4 is a block diagram illustrating a functional configuration of each of the apparatuses or devices included in a chat system according to the first embodiment;

FIG. 5 is a diagram illustrating an example of a conversation history database (DB) included in a first storage device;

FIG. 6 is a diagram illustrating an example of a file DB included in a second storage device;

FIG. 7 is a diagram illustrating an example of a chunk DB included in the second storage device;

FIG. 8 is a diagram illustrating an example of a user information DB included in the second storage device;

FIG. 9 is a diagram illustrating an example of a term dictionary DB included in the second storage device;

FIG. 10 is a sequence diagram illustrating the operation performed by a chat system according to the first embodiment;

FIGS. 11A and 11B are first diagrams each illustrating a prompt in the first embodiment;

FIG. 12 is a diagram illustrating an example of question data to which a description of a special term is appended, according to the first embodiment;

FIGS. 13A and 13B are first diagrams each illustrating a display example displayed on a display of a terminal apparatus, according to the first embodiment;

FIG. 14 is a first sequence diagram illustrating the operation performed by a chat system according to a second embodiment;

FIG. 15 is a second sequence diagram illustrating the operation performed by a chat system according to the second embodiment;

FIG. 16 is a first sequence diagram illustrating the operation performed by a chat system according to a third embodiment;

FIG. 17 is a diagram illustrating an example of a prompt generated in the third embodiment;

FIG. 18 is a first diagram illustrating a display example displayed on a display of a terminal apparatus according to the third embodiment;

FIG. 19 is a second diagram illustrating a display example displayed on a display of a terminal apparatus according to the third embodiment;

FIG. 20 is a third diagram illustrating a display example displayed on a display of a terminal apparatus according to the third embodiment;

FIG. 21 is a fourth diagram illustrating a display example displayed on a display of a terminal apparatus according to the third embodiment;

FIG. 22 is a second sequence diagram illustrating the operation performed by a chat system according to the third embodiment;

FIG. 23 is a diagram illustrating another example of a prompt generated in the third embodiment;

FIG. 24 is a first diagram illustrating a display example displayed on a display of a terminal apparatus according to a fourth embodiment;

FIG. 25 is a second diagram illustrating a display example displayed on a display of a terminal apparatus according to the fourth embodiment;

FIG. 26 is a sequence diagram illustrating the operation performed by a chat system according to the fourth embodiment;

FIG. 27 is a diagram illustrating an example of a prompt generated in the fourth embodiment;

FIG. 28 is a diagram illustrating an example of question data to which a description of a special term is appended, according to the fourth embodiment;

FIG. 29 is a diagram illustrating a system configuration of a chat system according to a fifth embodiment;

FIG. 30 is a block diagram illustrating a functional configuration of each of the apparatuses or devices included in a chat system according to the fifth embodiment;

FIG. 31 is a diagram illustrating an example of a workflow DB;

FIG. 32 is a first sequence diagram illustrating the operation performed by a chat system according to the fifth embodiment;

FIG. 33 is a first diagram illustrating a display example displayed on a display of a terminal apparatus according to the fifth embodiment;

FIG. 34 is a second diagram illustrating a display example displayed on a display of a terminal apparatus according to the fifth embodiment; and

FIG. 35 is a second sequence diagram illustrating the operation performed by a chat system according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

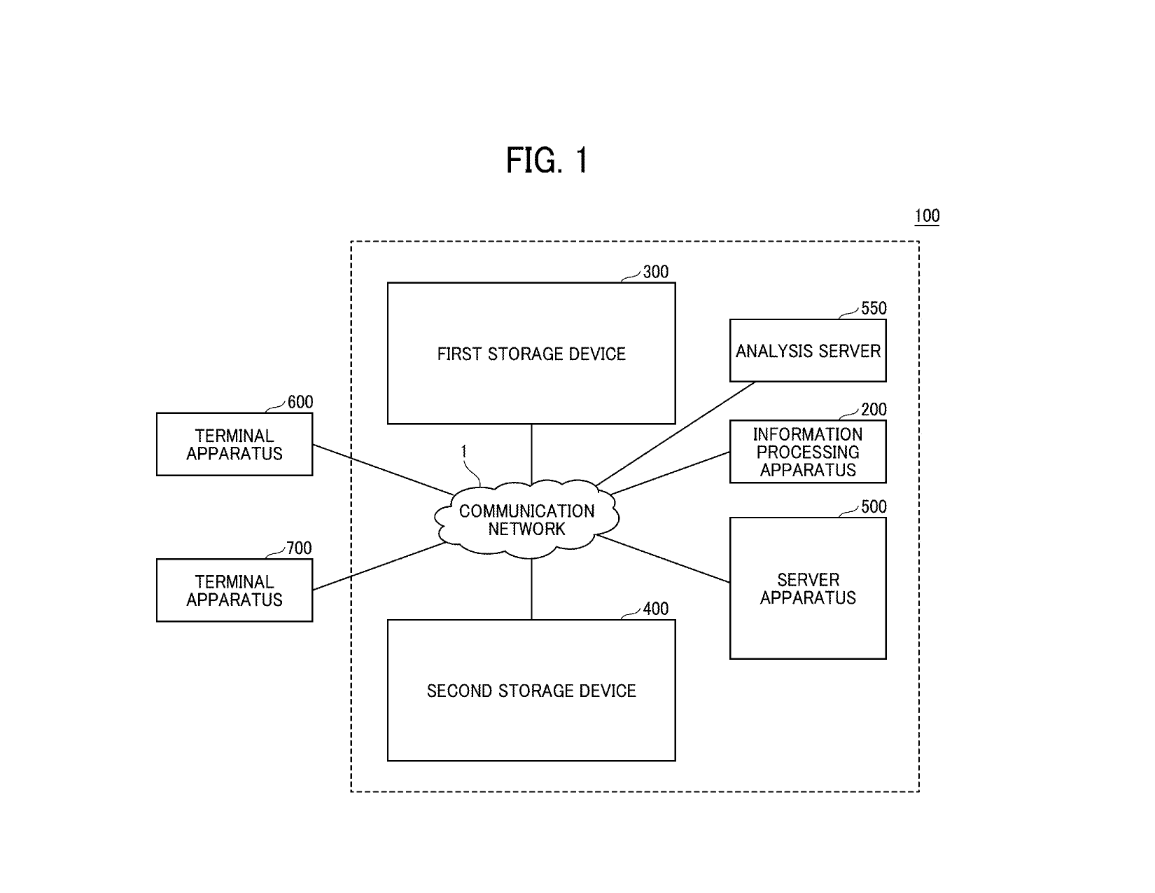

Embodiments of the present disclosure are described below with reference to the drawings. FIG. 1 is a diagram illustrating a system configuration of a chat system 100 according to a first embodiment.

The chat system 100, which is an example of an information processing system, includes an information processing apparatus 200, a first storage device 300, a second storage device 400, a server apparatus 500, and an analysis server 550, which are connected to each other via a communication network 1. The chat system 100 is connected to a terminal apparatus 600 and a terminal apparatus 700 via the communication network 1.

In the chat system 100, the information processing apparatus 200, the first storage device 300, the second storage device 400, the server apparatus 500, and the analysis server 550 operate in cooperation to provide a chatbot service to a user of the terminal apparatus 600.

The chat system 100 according to the present embodiment is, for example, an information processing apparatus implemented by a computer or an information processing system implemented by a plurality of computers. The chat system 100 may be, for example, an interactive agent that interacts with the user via the terminal apparatus 600. The chat system 100 according to the present embodiment is a program or a system for responding to a question from, for example, the user of the terminal apparatus 600. The chat system 100 provides a service for automatically responding by using, for example, artificial intelligence (AI) or knowledge including registered information and knowledges, and is also called an AI agent. Preferably, the chat system 100 supports execution of a predetermined task, such as a help desk task or a business negotiation, through interaction in which the chat system automatically responds to a voice or an input message from the user. The chat system 100 is used, for example, in a web conference, a website, or an application for a smartphone, or as an unmanned AI avatar in a virtual space of a metaverse (referred to as a metaverse space in the following description).

When question data indicating a question is input from the terminal apparatus 600, the information processing apparatus 200 outputs answer data indicating an answer to the question to the terminal apparatus 600.

The first storage device 300 stores, for example, conversation history information in which the question data input from the terminal apparatus 600 and the answer data output to the terminal apparatus 600 are associated with each other. The conversation history information may be managed for each tenant that uses the chat system 100. In the present embodiment, the tenant may be an organization to which the user who uses the chat system 100 belongs, such as a company for which the user works.

The second storage device 400 stores a file to be searched for outputting the answer data to the input question data. In the present embodiment, the file may be, for example, user-specific information that is not publicly disclosed. The user of the chat system 100 may be, for example, the tenant. In such a case, the user-specific information corresponds to information specific to the tenant. Alternatively, the user of the chat system 100 may be an individual user. In such a case, the user-specific information corresponds to information specific to the individual user.

In the following description, the user-specific information may be referred to as in-company information. The in-company information is an example of a file stored in the second storage device 400.

The in-company information is data managed by an organization to which multiple members belong, and may include data stored in a database managed by the organization. Examples of the organization may include a for-profit organization such as a company and a non-profit organization such as a hospital, a school, or a cram school. As an example, the in-company information managed by the hospital includes information on a patient, such as a medical record. In this case, the chat system 100 can generate answer data including diagnosis contents based on the information on the patient. In another example, the in-company information managed by the school or the cram school includes information on a learning status or a grade of the user such as a student. In this case, the chat system 100 can generate answer data including an appropriate exercise or a video lesson based on the information on the learning status or the grade.

The second storage device 400 may store a file for each tenant. Information obtained by dividing the file into predetermined units is stored in the second storage device 400 for each piece of divided information. In the following description, each piece of divided information is referred to as a chunk. In other words, the chunk in the present embodiment is a unit of information obtained by dividing the information indicated by the file into predetermined units. The second storage device 400 may store user information on users belonging to tenants for each tenant.

In addition, the second storage device 400 stores term information. In the term information, special terms such as abbreviations used in the tenant to which the user belongs and technical terms used in the industry to which the tenant belongs are associated with information indicating the meanings of these special terms. The term information may be information managed for each tenant, and the second storage device 400 stores the term information for each tenant.

The special term in the present embodiment refers to a term that is not included among general terms used in daily life, or a term that has the same pronunciation as one or more general terms but is used with a meaning different from the meanings of the general terms. In the following description of the present embodiment, a term associated with information indicating a meaning in the term information may be referred to as a special term.

The server apparatus 500 implements generative AI. The generative AI generates text data in accordance with a prompt being input, and outputs the generated text data to the information processing apparatus 200. Chat Generative Pretrained Transformer (Chat GPT^{®}) is one example of the generative AI. The prompt in the present embodiment is text data that describes an instruction or a question to the server apparatus 500 operating as the generative AI. A large-scale language model will be described in detail later.

The analysis server 550 performs analysis for dividing a file requested to be registered in the second storage device 400 into chunks.

The terminal apparatus 600 is operated, for example, by the user who uses the chat system 100. The terminal apparatus 700 is operated, for example, by an administrator who manages the chat system 100. Each of the terminal apparatus 600 and the terminal apparatus 700 may be, for example, a smartphone or a tablet terminal.

In the chat system 100 according to the present embodiment, when the terminal apparatus 600 receives question data indicating a question input by the user, the terminal apparatus 600 transmits the question data to the information processing apparatus 200.

In response to receiving the input of the question data, the information processing apparatus 200 acquires, from the first storage device 300, conversation history information for a certain period of time before the question is input to the terminal apparatus 600. The information processing apparatus 200 outputs, to the server apparatus 500, a prompt requesting generation of a query (i.e., a search key) for searching for a chunk stored in the second storage device 400, using the question input by the user and the conversation history information acquired by the information processing apparatus 200.

The server apparatus 500 inputs the prompt requesting the generation of the query to a large-scale language model, and transmits response data corresponding to the prompt, which is output from the large-scale language model, to the information processing apparatus 200. The information processing apparatus 200 searches the second storage device 400 using the output data received from the server apparatus 500 as a query, and acquires a chunk as a search result.

The information processing apparatus 200 outputs, to the server apparatus 500, a prompt requesting generation of answer data to the question data input from the terminal apparatus 600, using, as an information source, the chunk acquired as the search result.

The server apparatus 500 inputs the prompt requesting the generation of the answer data to the large-scale language model, and transmits the response data corresponding to the prompt, which is output from the large-scale language model, to the information processing apparatus 200. The information processing apparatus 200 transmits the output data received from the server apparatus 500 to the terminal apparatus 600 as the answer data.

The terminal apparatus 600 displays the answer data received from the information processing apparatus 200 as an answer to the question input by the user.

In this way, the large-scale language model is caused to generate the answer data to the question data based on the file stored in the second storage device 400 in the present embodiment. In other words, according to the present embodiment, the large-scale language model is caused to generate the answer data to the question data input by the user, based on the user-specific information that is not publicly disclosed. Accordingly, according to the present embodiment, a response can be provided based on a file stored by the user in the second storage device 400.

In the present embodiment, the information source for generating the answer data is the file obtained as the search result by searching the second storage device 400 based on the conversation history information before the question data is input. As a result, according to the present embodiment, the number of files to be used as information sources is narrowed down to be transmitted to the server apparatus 500, and the accuracy of the answer to the question is increased while controlling the number of inputs to fit within the token limits of the large-scale language model.

In the chat system 100 according to the present embodiment, when the question data is input from the terminal apparatus 600, the information processing apparatus 200 determines whether a special term is included in the question data. In the case where it is determined that a special term is included in the question data, the information processing apparatus 200 includes information indicating the meaning of the special term in a search request to be transmitted to the second storage device 400 for searching for a file serving as an information source. The information processing apparatus 200 also includes the information indicating the meaning of the special term in the prompt requesting the generation of the answer data to the question data.

In this way, even when a special term is included in the question data input by the user through the terminal apparatus 600, the generative AI implemented by the server apparatus 500 can output appropriate answer data. Thus, the accuracy of the answer data to the question data is increased.

In the example of FIG. 1, the information processing apparatus 200, the first storage device 300, and the second storage device 400 are illustrated as separate apparatuses or devices. However, the configuration is not limited thereto. In another embodiment, the information processing apparatus 200 may include the first storage device 300 and the second storage device 400. Also, in the example of FIG. 1, the information processing apparatus 200 and the analysis server 550 are illustrated as separate apparatuses. However, the configuration is not limited thereto. In another embodiment, the information processing apparatus 200 may include the functions of the analysis server 550. In other words, the information processing apparatus 200 may also function as the analysis server 550.

In FIG. 1, the information processing apparatus 200 may be implemented by at least one information processing apparatus, or may be implemented by a plurality of information processing apparatuses.

Further, the chat system 100 may include only the information processing apparatus 200 and the terminal apparatus 600, such that any other apparatus may not be included in the chat system 100.

An example of a hardware configuration of each of the apparatuses or devices included in the chat system 100 is described below.

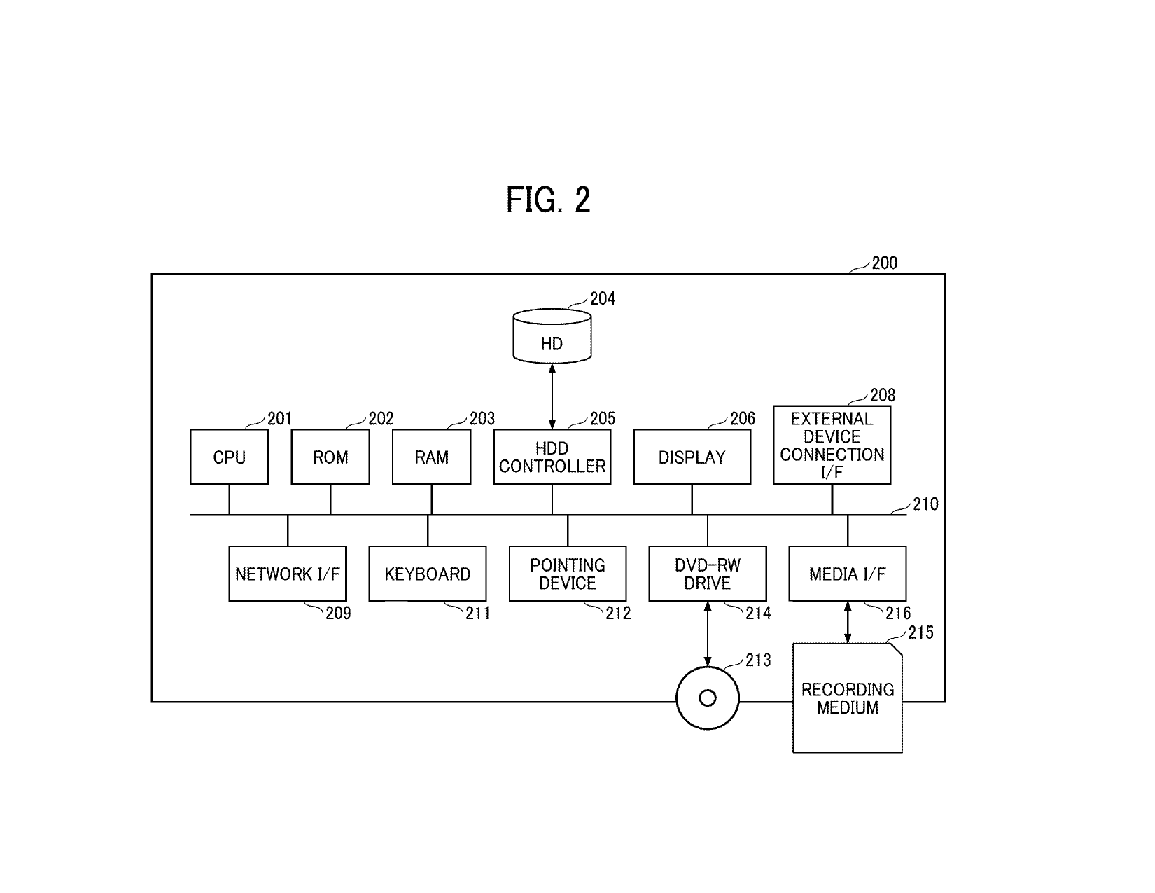

In the present embodiment, the information processing apparatus 200, the first storage device 300, the second storage device 400, the server apparatus 500, and the analysis server 550 are each implemented by a general-purpose computer. As an example, a hardware configuration of the information processing apparatus 200 is described below with reference to FIG. 2.

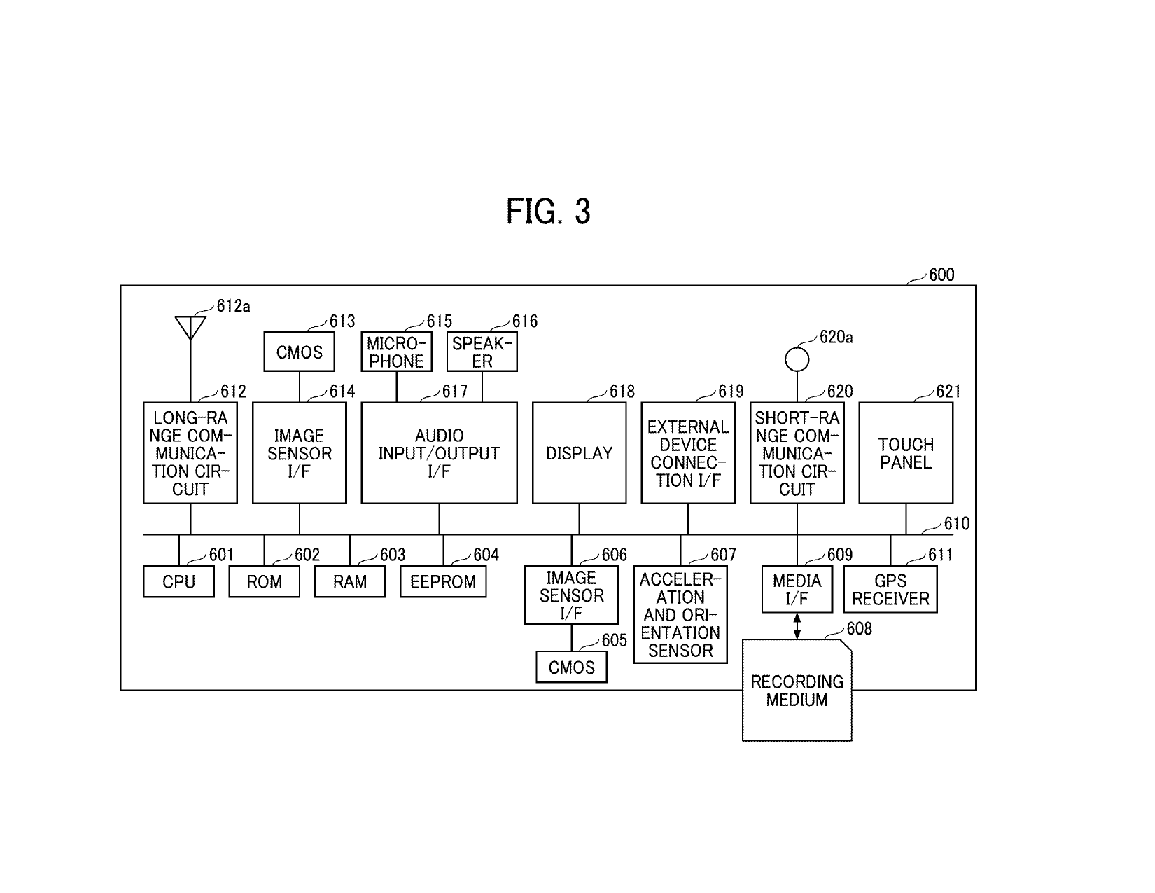

Further, in the present embodiment, the terminal apparatuses 600 and 700 are each implemented by a smartphone. An example of a hardware configuration of the terminal apparatus 600 is described below with reference to FIG. 3.

FIG. 2 is a block diagram illustrating a hardware configuration of the information processing apparatus 200. The information processing apparatus 200 illustrated in FIG. 2, which is implemented by a computer (information processing apparatus), includes a central processing unit (CPU) 201, a read-only memory (ROM) 202, a random-access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disc-rewritable (DVD-RW) drive 214, and a media I/F 216.

The CPU 201 controls the overall operation of the information processing apparatus 200. The ROM 202 stores a program such as an initial program loader (IPL) used for booting the CPU 201. The RAM 203 is used as a work area for the CPU 201. The HD 204 stores various data such as a program. The HDD controller 205 controls the reading of various data from, or the writing of various data to, the HD 204 under the control of the CPU 201. The display 206 displays various types of information, such as a cursor, a menu, a window, text, or an image. The external device connection I/F 208, which may be implemented by an interface circuit, is an interface for connection with various external devices. Examples of the external devices in this case include, but are not limited to, a universal serial bus (USB) memory and a printer. The network I/F 209, which may be implemented by an interface circuit, is an interface for data communication through a communication network. The bus line 210 is, for example, an address bus or a data bus that electrically connects the components illustrated in FIG. 2, such as the CPU 201.

The keyboard 211 is an example of an input device provided with multiple keys used for inputting characters, numerical values, and various instructions. The pointing device 212 is an example of an input device that allows selection or execution of various instructions, selection of a processing target, and movement of a cursor. The DVD-RW drive 214 controls the reading of various data from, or the writing of various data to, a DVD-RW 213, which is an example of a removable recording medium. The removable recording medium is not limited to a DVD-RW and may be, for example, a digital versatile disc recordable (DVD-R). The media I/F 216 controls the reading of data from, or the writing (storing) of data to (in), a recording medium 215 such as a flash memory.

FIG. 3 is a block diagram illustrating a hardware configuration of the terminal apparatus 600. The terminal apparatus 600 according to the present embodiment includes a CPU 601, a ROM 602, a RAM 603, an electrically erasable programmable read-only memory (EEPROM) 604, a complementary metal oxide semiconductor (CMOS) sensor 605, an image sensor I/F 606, an acceleration and orientation sensor 607, a media I/F 609, a bus line 610, and a global positioning system (GPS) receiver 611.

The CPU 601 is an arithmetic processing unit, which controls the overall operation of the terminal apparatus 600. The ROM 602 stores, for example, a program used by the CPU 601 and a program such as an IPL used for booting the CPU 601. The RAM 603 is used as a work area for the CPU 601. The EEPROM 604 reads or writes various data such as a program for the smartphone under the control of the CPU 601. The ROM 602, the RAM 603, and the EEPROM 604 are examples of storage devices for the terminal apparatus 600.

The CMOS sensor 605 is an example of a built-in imaging device that captures an image of a subject (e.g., a self-image of the user) under the control of the CPU 601 to obtain image data. Instead of the CMOS sensor, an imaging device such as a charge-coupled device (CCD) sensor may be used.

The image sensor I/F 606 is a circuit that controls the driving of the CMOS sensor 605. The acceleration and orientation sensor 607 includes various sensors, such as an electromagnetic compass or gyrocompass for detecting geomagnetism and an acceleration sensor. The media I/F 609 controls the reading of data from, or the writing (storing) of data to (in), a recording medium 608 such as a flash memory. The bus line 610 is, for example, an address bus or a data bus that electrically connects the components illustrated in FIG. 3, such as the CPU 601. The GPS receiver 611 receives a GPS signal from a GPS satellite.

The terminal apparatus 600 further includes a long-range communication circuit 612, an antenna 612a for the long-range communication circuit 612, a CMOS sensor 613, an image sensor I/F 614, a microphone 615, a speaker 616, an audio input/output I/F 617, a display 618, an external device connection I/F 619, a short-range communication circuit 620, an antenna 620a for the short-range communication circuit 620, and a touch panel 621.

The long-range communication circuit 612 is a circuit for communicating with other devices via a communication network. The CMOS sensor 613 is an example of a built-in imaging device that captures an image of a subject under the control of the CPU 601 to obtain image data. The image sensor I/F 614 is a circuit that controls the driving of the CMOS sensor 613. The microphone 615 is a built-in circuit that converts sound into electrical signals. The speaker 616 is a built-in circuit that converts electrical signals into physical vibration to produce sound such as music or voice. The audio input/output I/F 617 is a circuit that processes the input and output of audio signals between the microphone 615 and the speaker 616 under the control of the CPU 601.

The display 618 is an example of a display that displays an image of a subject and various icons, and may be implemented by, for example, a liquid crystal display or an organic electro-luminescence (EL) display. The external device connection I/F 619, which may be implemented by an interface circuit, is an interface for connection with various external devices. The short-range communication circuit 620 is a communication circuit in compliance with a communication protocol such as the near field communication (NFC) or Bluetooth^{®}. The touch panel 621 is an example of an input device that allows the user to operate the terminal apparatus 600 by touching or pressing the screen of the display 618. The display 618 is an example of a display device included in the terminal apparatus 600.

The hardware configuration illustrated in FIG. 3 is one example of the hardware configuration of the terminal apparatus 600. However, the hardware configuration of the terminal apparatus 600 is not limited thereto. For example, the terminal apparatus 600 may have the hardware configuration illustrated in FIG. 2.

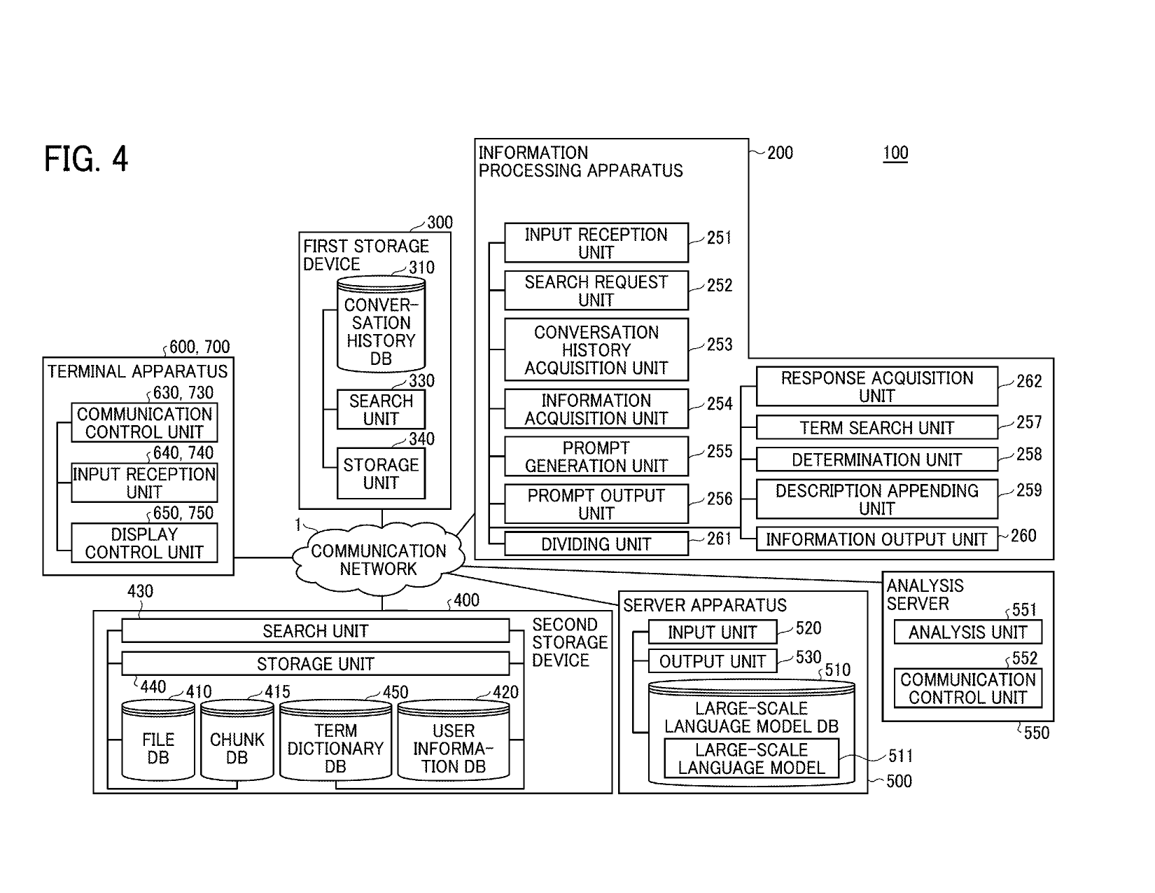

With reference to FIG. 4, the functions of each of the apparatuses or devices included in the chat system 100 are described below. FIG. 4 is a block diagram illustrating a functional configuration of each of the apparatuses or devices included in the chat system 100 according to the first embodiment.

The functional units of the first storage device 300 are described below. The first storage device 300 includes a conversation history database (DB) 310, a search unit 330, and a storage unit 340.

The conversation history DB 310 may be implemented by, for example, a memory included in the first storage device 300, and the search unit 330 and the storage unit 340 provide functions implemented by the CPU of the first storage device 300 reading out and executing programs stored in the memory.

The conversation history DB 310 stores the conversation history information in which the question input from the terminal apparatus 600 and the answer output to the terminal apparatus 600 are associated with each other. In response to receiving the search request from the information processing apparatus 200, the search unit 330 searches the conversation history DB 310 and transmits a search result to the information processing apparatus 200. When the question data is input and the answer data is output in the information processing apparatus 200, the storage unit 340 stores the conversation history information including the question data and the answer data in the conversation history DB 310.

The first storage device 300 may also include a DB that stores a set of question and answer information in which a question and an answer are associated with each other. In this case, in response to receiving the input of the question from the terminal apparatus 600, the first storage device 300 can also search the set of question and answer information to output an answer. The question and answer information may be stored for each tenant that uses the chat system 100.

The functional units of the second storage device 400 are described below. The second storage device 400 includes a file DB 410, a chunk DB 415, a user information DB 420, a term dictionary DB 450, a search unit 430, and a storage unit 440.

In the second storage device 400, the file DB 410, the chunk DB 415, the user information DB 420, and the term dictionary DB 450 may be each implemented by, for example, a memory of the second storage device 400, and are provided for each tenant. The search unit 430 and the storage unit 440 of the second storage device 400 each provide the functions implemented by the CPU of the second storage device 400 reading out and executing programs stored in the memory.

The file DB 410 stores files for each tenant. The chunk DB 415 stores chunks, which are units of information obtained by dividing a file into the predetermined units, for each file. In the present embodiment, the chunks stored in the chunk DB 415 are parts of the file and can be an example of the file stored in the storage unit.

The user information DB 420 stores the user information on the users belonging to the tenants for each tenant. The term dictionary DB 450 stores the term information in which the special terms and the information indicating the meanings of the special terms are associated with each other.

In response to receiving the search request from the information processing apparatus 200, the search unit 430 searches the chunk DB 415 and transmits a search result to the information processing apparatus 200. Also, in response to receiving the search request from the information processing apparatus 200, the search unit 430 searches the term dictionary DB 450 and transmits a search result to the information processing apparatus 200.

When an operation for uploading a file is performed by, for example, the administrator of the chat system 100, the storage unit 440 newly stores the file in the file DB 410. Also, in response to receiving a chunk obtained by dividing the file from the information processing apparatus 200, the storage unit 440 stores the chunk in the chunk DB 415. Further, the storage unit 440 stores term information registered via the terminal apparatus 700 in the term dictionary DB 450. The DBs included in the first storage device 300 and the second storage device 400 will be described in detail later.

The functional units of the server apparatus 500 are described below. The server apparatus 500 includes a large-scale language model DB 510, an input unit 520, and an output unit 530. The large-scale language model DB 510 stores a large-scale language model 511 for implementing a generative AI.

The large-scale language model 511 of the present embodiment is a computer language model that is generated by executing a training process using a huge amount of unlabeled text as training data and includes an artificial neural network having a large number of parameters. The large-scale language model 511 is sufficiently trained by a method for learning a context, such as next-sentence prediction to understand a context by determining whether sentence 1 and sentence 2 are consecutive or a masked language model to understand a context by masking a word in a sentence and predicting the masked word from words that come before and after the masked word, to capture many sentence structures and meanings of human language.

The input unit 520 inputs a prompt transmitted from the information processing apparatus 200 to the large-scale language model 511. The output unit 530 outputs (transmits) output data output from the large-scale language model 511 to the information processing apparatus 200. In other words, the output unit 530 transmits the answer data output from the large-scale language model 511 to the information processing apparatus 200.

The functional units of the analysis server 550 are described below. The analysis server 550 includes an analysis unit 551 and a communication control unit 552. The analysis unit 551 performs analysis for dividing a file requested to be registered in the second storage device 400 into chunks. The communication control unit 552 controls communication between the analysis server 550 and other apparatuses. Specifically, the communication control unit 552 receives an analysis request to the analysis server 550, and transmits an analysis result provided by the analysis unit 551.

The functional units of the terminal apparatuses 600 and 700 are described below. The terminal apparatus 600 includes a communication control unit 630, an input reception unit 640, and a display control unit 650. The terminal apparatus 700 includes a communication control unit 730, an input reception unit 740, and a display control unit 750. The communication control units 630 and 730, the input reception units 640 and 740, and the display control units 650 and 750 included, respectively, in the terminal apparatuses 600 and 700 may be implemented by web browsers included in the respective terminal apparatuses, or by means different from the web browsers.

The communication control unit 630 controls communication between the terminal apparatus 600 and the information processing apparatus 200. The communication control unit 730 controls communication between the terminal apparatus 700 and the information processing apparatus 200. The input reception unit 640 receives input to the terminal apparatus 600. The input reception unit 740 receives input to the terminal apparatus 700. The display control unit 650 controls display on the display of the terminal apparatus 600. The display control unit 750 controls display on the display of the terminal apparatus 700.

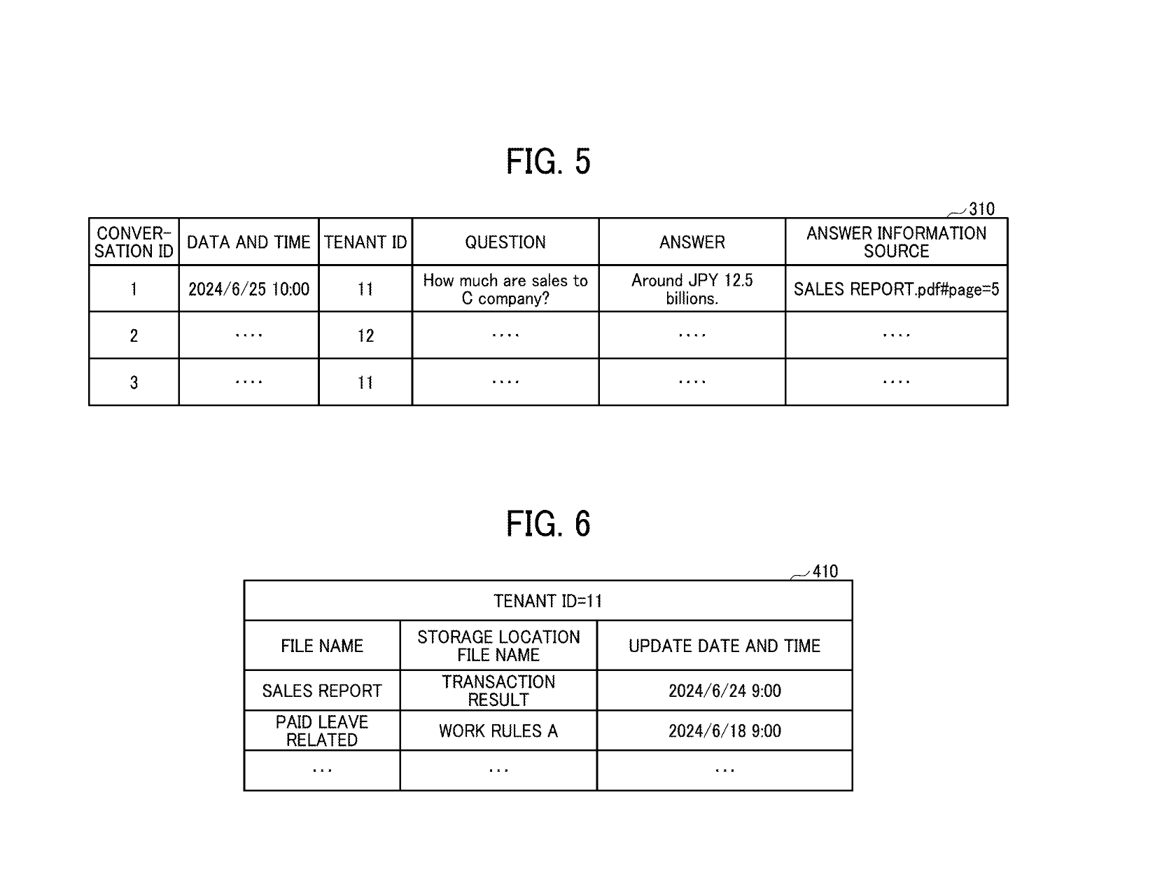

At this point, before the description of the functional units of the information processing apparatus 200, the DBs included in the first storage device 300 and the second storage device 400 are described below with reference to FIGS. 5 to 8.

FIG. 5 is a diagram illustrating an example of the conversation history DB 310 included in the first storage device 300. The conversation history information stored in the conversation history DB 310 illustrated in FIG. 5 includes, as information items, a conversation identification (ID), a date and time, a tenant ID, a question, an answer, and an information source of the answer. In the conversation history information, the values of the respective items are associated with each other.

The item “conversation ID” has a value, which is an identifier for identifying a conversation. The conversation includes a set of question and answer. The item “date and time” has a value indicating the date and time when a question is input to the terminal apparatus 600 or the date and time when an answer is output to the terminal apparatus 600. The item “tenant ID” has a value, which is an identifier for identifying a tenant to which the user operating the terminal apparatus 600 belongs. The terminal apparatus 600 is a particular terminal apparatus that has received the question input by the user.

The item “question” has a value indicating data (question data) input to the terminal apparatus 600, and is expressed as a sentence including the question. The item “answer” has a value indicating data (answer data) output to the terminal apparatus 600, and is expressed as a sentence including the answer.

In the following description, data output to the terminal apparatus 600 as an answer is referred to as answer data. In other words, the conversation history information of the present embodiment includes one or more pieces of conversation history information each relating to a conversation including a set of question and answer. Specifically, the conversation history information includes the conversation ID for identifying the conversation history information, the tenant ID for identifying the tenant to which the user operating the terminal apparatus 600 belongs, the date and time when the question data is input or the date and time when the answer data is output, the question data, and the answer data.

The item “answer information source” has a value indicating an information source of the answer data. Specifically, for example, the value of the item “answer information source” is information for identifying a file serving as the information source of the answer data. The information for identifying a file may be a link indicating the storage location of the file.

FIG. 6 is a diagram illustrating an example of the file DB 410 included in the second storage device 400. In the file DB 410 of the present embodiment, files are stored for each tenant, and may be managed for each tenant.

The file DB 410 may be divided into multiple storage areas according to the types of files to be stored. In other words, the file DB 410 may have multiple folders created according to the types of files.

In the file DB 410, for example, the file name of a file to be stored, the folder name in which the file is stored, the update date and time of the file may be stored in association with the file. In the example of FIG. 6, the information indicates that a file having the file name “sales report” is stored in a folder having the folder name “transaction result” at 9:00 on Jun. 24, 2024. Further, in the example of FIG. 6, the information indicates that a file having the file name “paid leave related” is stored in a folder having the folder name “work rules A” at 9:00 on Jun. 18, 2024.

In the present embodiment, the folder in which a file is to be stored is created according to the type of information indicated by the file. However, the way to create a folder is not limited thereto. The folder to be created in the file DB 410 may be created, for example, for each business content in the tenant or for each department in the tenant. The setting of the folders in the file DB 410 may be set by the administrator of the tenant using the chat system 100 as desired. In the present embodiment, a configuration may be adopted in which no folders are created in the file DB 410.

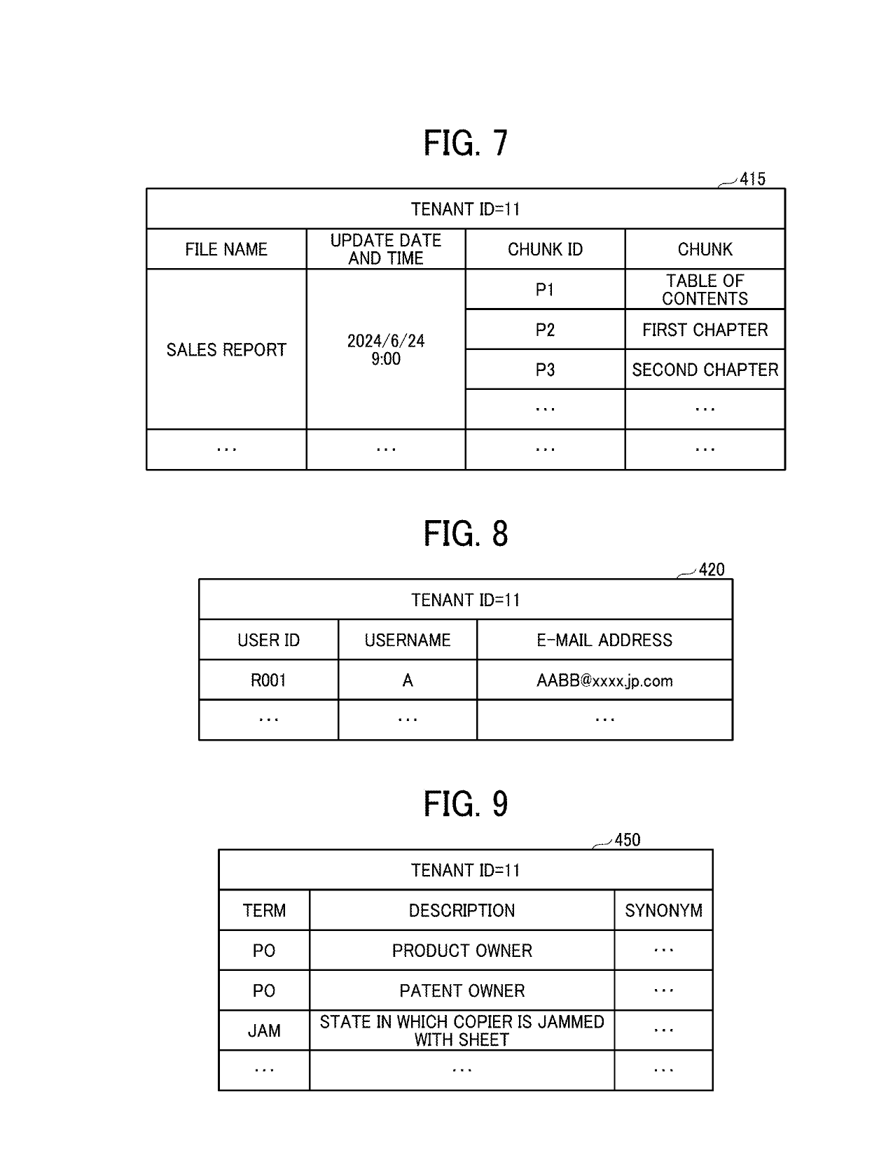

FIG. 7 is a diagram illustrating an example of the chunk DB 415 included in the second storage device 400. In the table illustrated in FIG. 7, a file name serving as information for identifying a file, an update date and time of the file, and a chunk ID for identifying a chunk are stored in association with a corresponding chunk.

In the example of FIG. 7, one page of the information contained in a document having the file name “sales report” is set as a chunk, and a page number is set as a chunk ID for identifying the chunk.

The unit of the chunk is not limited to one page of a file, and may be, for example, one paragraph or one chapter of the file.

FIG. 8 is a diagram illustrating an example of the user information DB 420 included in the second storage device 400. The user information stored in the user information DB 420 of the present embodiment may be managed for each tenant.

The user information in the present embodiment includes, as information items, a tenant ID, a user ID, a username, and an e-mail address. The item “tenant ID” has a value, which is an identifier for identifying a tenant to which the user identified with the user ID belongs. The item “user ID” has a value, which is an identifier for identifying the user operating the terminal apparatus 600. The item “username” has a value indicating the name of the user identified with the user ID. The item “e-mail address” has a value indicating an e-mail address of the user identified with the user ID.

In the present embodiment, the user information DB 420 is stored in the second storage device 400. However, in the second storage device 400, the user information DB 420 may not be stored as long as the file DB 410, the chunk DB 415, and the term dictionary DB 450 are stored.

FIG. 9 is a diagram illustrating an example of the term dictionary DB 450 included in the second storage device 400. The term information stored in the term dictionary DB 450 of the present embodiment may be managed for each tenant. Further, the term information in the present embodiment may be stored in advance in the term dictionary DB 450.

The term information in the present embodiment includes, as information items, a tenant ID, a term, a description, and a synonym. The item “tenant ID” has a value, which is an identifier for identifying a tenant to which the user identified with the user ID belongs. The item “term” has a value indicating a word that is regarded as a special term. The item “description” has a value, which is text data indicating the meaning of the special term indicated by the value of the item “term.” In other words, the value of the item “description” is text data indicating the description of the special term. The item “synonym” has a value indicating a synonym having a meaning similar to that of the special term that is the value of the item “term.” In the present embodiment, the text data indicating the description of the special term and a synonym having a meaning similar to that of the special term are examples of information indicating the meaning of the special term.

In the example of FIG. 9, the term information includes text data indicating the description of the special term. However, in the term information, the text data indicating the description of the special term may not be included as long as the special term and the synonym having a meaning similar to that of the special term are included.

Referring back to FIG. 4, the functional units of the information processing apparatus 200 are described below.

The information processing apparatus 200 according to the present embodiment includes an input reception unit 251, a search request unit 252, a conversation history acquisition unit 253, an information acquisition unit 254, a prompt generation unit 255, a prompt output unit 256, a term search unit 257, a determination unit 258, a description appending unit 259, an information output unit 260, a dividing unit 261, and a response acquisition unit 262. These functional units provide functions implemented by the CPU 201 of the information processing apparatus 200 reading out and executing instructions included in one or more programs installed in, for example, the HD 204.

The input reception unit 251 receives various inputs to the information processing apparatus 200. Specifically, the input reception unit 251 receives input of question data from the terminal apparatus 600. The input reception unit 251 also receives an instruction to store a file in the second storage device 400 from the terminal apparatus 700. Further, the input reception unit 251 receives input of term information from the terminal apparatus 700.

The search request unit 252 requests the first storage device 300 or the second storage device 400 to perform a search. Specifically, the search request unit 252 transmits, to the first storage device 300, a search request for searching the conversation history DB 310 using the question data as a search key. The search request unit 252 also transmits, to the second storage device 400, a search request for searching the chunk DB 415 based on a query generated by the server apparatus 500.

The conversation history acquisition unit 253 acquires conversation history information from the first storage device 300. The conversation history information is a search result obtained by searching the conversation history DB 310 according to the search request transmitted by the search request unit 252.

The information acquisition unit 254 acquires a chunk from the second storage device 400. The chunk is a search result obtained by searching the chunk DB 415 according to the search request transmitted by the search request unit 252. The information acquisition unit 254 also acquires term information stored in the term dictionary DB 450 of the second storage device 400.

The prompt generation unit 255 generates a prompt to be output to the server apparatus 500. For example, when information to be included in the prompt is acquired, the prompt generation unit 255 generates a prompt including the acquired information in a predetermined format.

Specifically, the prompt generation unit 255 generates a prompt requesting creation of a search query for searching the chunk DB 415 of the second storage device 400. The prompt generation unit 255 also generates a prompt requesting generation of an answer to the question. Further, the prompt generation unit 255 generates a prompt requesting extraction of a special term included in the question data input from the terminal apparatus 600. Furthermore, the prompt generation unit 255 generates a prompt requesting extraction of a special term included in a chunk stored in the chunk DB 415.

The prompt output unit 256 outputs the prompt generated by the prompt generation unit 255 to the server apparatus 500.

The term search unit 257 searches the question data input from the terminal apparatus 600, using a term included in the term information stored in the term dictionary DB 450 as a search key. The term search unit 257 also searches the chunk acquired by the information acquisition unit 254, using the term included in the term information as a search key. Further, the term search unit 257 searches a search result obtained by the server apparatus 500 extracting the special term from the chunk, using the special term included in the term information as a search key.

The determination unit 258 determines whether the special term is included in the question data based on the search result provided by the term search unit 257. The determination unit 258 also determines whether the special term is included in the chunk based on the search result provided by the term search unit 257.

In the case where the determination unit 258 determines that the special term is included in the question data, the description appending unit 259 appends, to the end of the question data, a description associated with the special term included in the question data in the term information or a synonym associated with the special term. In the case where the determination unit 258 determines that the special term is included in the chunk, the description appending unit 259 appends, to the end of the chunk, a description associated with the special term included in the chunk in the term information and a synonym associated with the special term.

As described above, in the present embodiment, in the case where the determination unit 258 determines that the special term is included in the question data, the prompt generation unit 255 generates a prompt including the question data and the description associated with the special term. Since the prompt output unit 256 transmits the prompt that includes the question data and the description associated with the special term to the server apparatus 500, a response in consideration of the meaning of the special term included in the question can be obtained.

For example, it is assumed that the question data contains a content indicating “Please tell me the setting of RPA” and the term dictionary DB 450 stores a description of “RPA: Robotic Process Automation, automation software.” In this case, the determination unit 258 determines that the “RPA” is a special term, and the prompt generation unit 255 appends information indicating “RPA: Robotic Process Automation, automation software” to the question data to generate a prompt. As a result, the server apparatus 500 can generate an appropriate answer after understanding the exact meaning of the RPA.

The information output unit 260 outputs various types of information to the outside of the information processing apparatus 200. Specifically, for example, the information output unit 260 outputs the answer data to the question to the terminal apparatus 600. The information output unit 260 also outputs the conversation history information to the first storage device 300.

The dividing unit 261 divides a file to be stored in the file DB 410 into chunks and stores the divided chunks in the chunk DB 415. The response acquisition unit 262 acquires the response data output as a response to the prompt from the large-scale language model 511 of the server apparatus 500.

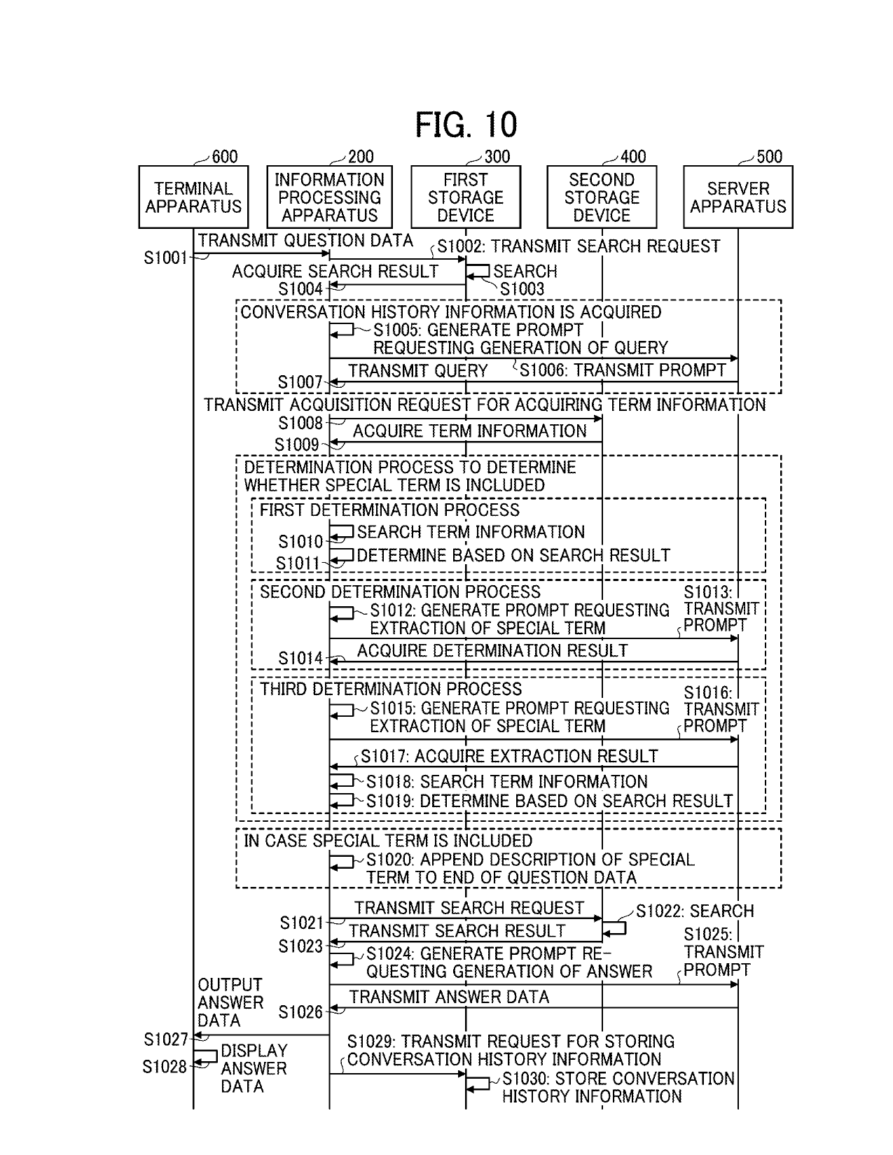

The operation of the chat system 100 according to the present embodiment is described below. First, with reference to FIG. 10, the operation performed by the chat system 100 when the input of the question data is received from the terminal apparatus 600 is described below.

FIG. 10 is a sequence diagram illustrating the operation performed by the chat system 100 according to the first embodiment.

In step S1001, in the chat system 100, in response to receiving input of a question with the input reception unit 640, the terminal apparatus 600 transmits question data indicated by the question to the information processing apparatus 200. The question data transmitted at this point may be assigned with a tenant ID identifying the tenant to which the user operating the terminal apparatus 600 belongs.

In step S1002, in response to receiving an input of the question data with the input reception unit 251, the information processing apparatus 200 transmits, with the search request unit 252, a search request including the tenant ID to the first storage device 300.

In step S1003, in response to receiving the search request, the first storage device 300 searches the conversation history DB 310 with the search unit 330.

The processing performed by the search unit 330 is described below. The search unit 330 identifies one or more pieces of conversation history information including the tenant ID included in the search request from among the pieces of conversation history information stored in the conversation history DB 310, and acquires, as a search result, one or more pieces of conversation history information having a content relating to the question indicated by the question data from the identified pieces of conversation history information.

Specifically, the search unit 330 identifies one or more pieces of conversation history information including the tenant ID included in the search request, and acquires, from among the identified pieces of conversation history information, one or more pieces of conversation history information corresponding to the conversations that have continued until immediately before the question data is input in step S1001.

The conversation history information corresponding to the conversations that have continued until immediately before the question data is input in step S1001 refers to conversation history information that has been stored within a certain period of time between the time when the question data is input and the time when the answer data is last output before the input of the question data. In the present embodiment, when next question data is input within a certain period time after the answer data is output, the series of questions and answers within a certain period time are regarded as responses relating to the same inquiry.

As described above, the chat system 100 acquires the conversation history information having a content that is relating to the question indicated by the question data.

After searching the conversation history DB 310, the search unit 330 of the first storage device 300 transmits the search result to the information processing apparatus 200. In step S1004, the information processing apparatus 200 acquires the conversation history information with the conversation history acquisition unit 253.

When the conversation history information is acquired from the first storage device 300 as a search result, the information processing apparatus 200 performs the processes in steps S1005 to S1007.

The case where the conversation history information is acquired as the search result refers to a case where, before the question data input in step S1001 is input, other question data relating to the question indicated by the question data input in step S1001 is input and answer data corresponding to the other question data is output. In this case, the conversation history information including the other question data and the answer data corresponding to the other question data is stored in the conversation history DB 310.

In the case where the conversation history information is not acquired from the first storage device 300 as the search result, the information processing apparatus 200 proceeds to step S1008. The case where the conversation history information is not acquired as the search result refers to a case where the question data input in step S1001 is the first question in the inquiry.

In step S1005, the information processing apparatus 200 generates, with the prompt generation unit 255, a prompt requesting generation of a query for searching the file DB 410. At this time, the prompt generation unit 255 generates a prompt requesting generation of a query based on the question data input in step S1001 and the conversation history information acquired by the conversation history acquisition unit 253.

In step S1006, the information processing apparatus 200 transmits, with the prompt output unit 256, the prompt requesting generation of a query to the server apparatus 500.

In step S1007, the server apparatus 500 inputs the prompt to the large-scale language model 511 with the input unit 520, and transmits response data to the prompt output from the large-scale language model 511 to the information processing apparatus 200 as a query with the output unit 530.

In step S1008, when acquiring the response data with the response acquisition unit 262, the information processing apparatus 200 transmits, with the information acquisition unit 254, an acquisition request for acquiring term information to the second storage device 400. The acquisition request for acquiring term information transmitted to the second storage device 400 at this point may include the tenant ID. In step S1009, the information processing apparatus 200 acquires the term information stored in the term dictionary DB 450 of the second storage device 400.

The information processing apparatus 200 performs, with the determination unit 258, a determination process to determine whether a special term included in the term information acquired in step S1009 is included in the question data input in step S1001.

The determination process of the present embodiment is described below. The determination process of the present embodiment includes a first determination process, a second determination process, and a third determination process. The first determination process is performed in the information processing apparatus 200. The second determination process and the third determination process require the large-scale language model 511 to make the determination.

The information processing apparatus 200 according to the present embodiment performs at least one of the first, second, and third determination processes. The determination process performed in the information processing apparatus 200 can be set in advance by, for example, the administrator of the chat system 100, or can be set for each tenant via the terminal apparatus 700.

First, the first determination process is described below. In step S1010, when acquiring the term information with the information acquisition unit 254, the information processing apparatus 200 searches, with the term search unit 257, the question data based on the special term and the synonym included in the term information.

In step S1011, the information processing apparatus 200 determines, with the determination unit 258, whether the special term is included in the question data based on the search result provided by the term search unit 257. Specifically, when the special term is extracted from the question data as a search result, the determination unit 258 determines that the special term is included in the question data, and the process proceeds to step S1020, which will be described later. When the special term is not extracted from the question data as a search result, the determination unit 258 determines that the special term is not included in the question data, and the process proceeds to step S1021, which will be described later.

The first determination process has been described above. In the first determination process, the determination process is performed based on the term information prepared in advance and the question data being input. Thus, the result of the determination can be obtained with high accuracy in a short time.

Subsequently, the second determination process is described below. In step S1012, after acquiring the term information with the information acquisition unit 254, the information processing apparatus 200 generates, with the prompt generation unit 255, a prompt requesting extraction of the special term from the question data. At this time, the prompt generation unit 255 includes the term information acquired by the information acquisition unit 254 in the prompt. The prompt generated in step S1012 will be described in detail later.

In step S1013, the information processing apparatus 200 transmits, with the prompt output unit 256, the generated prompt to the server apparatus 500. In step S1014, the information processing apparatus 200 acquires, with the response acquisition unit 262, the determination result, which is the response data output from the large-scale language model 511, from the server apparatus 500.

In the case where the special term is included in the determination result acquired from the server apparatus 500, the information processing apparatus 200 proceeds to step S1020, which will be described later. In the case where the special term is not included the determination result acquired from the server apparatus 500, the information processing apparatus 200 proceeds to step S1021, which will be described later.

The second determination process has been described above. In the second determination process, the special term is extracted by the generative AI implemented by the server apparatus 500. Thus, even the special term not included in the term information can be flexibly extracted.

Subsequently, the third determination process is described below. In step S1015, after acquiring the term information with the information acquisition unit 254, the information processing apparatus 200 generates, with the prompt generation unit 255, a prompt requesting extraction of the special term from the question data. At this time, the prompt generation unit 255 does not include the term information acquired by the information acquisition unit 254 in the prompt. The prompt generated in step S1015 will be described in detail later.

In step S1016, the information processing apparatus 200 transmits, with the prompt output unit 256, the generated prompt to the server apparatus 500. In step S1017, the information processing apparatus 200 acquires, with the response acquisition unit 262, from the server apparatus 500, the extraction result that is output from the large-scale language model 511 and includes the special term extracted from the question data as the response data.

In step S1018, the information processing apparatus 200 searches, with the term search unit 257, the term information acquired by the information acquisition unit 254 using the term included in the extraction result as a search key, which is acquired from the large-scale language model 511.

In step S1019, the information processing apparatus 200 determines, with the determination unit 258, whether the special term is included in the question data based on the search result provided by the term search unit 257. Specifically, in the case where the term information includes a term that matches the term included in the extraction result provided by the large-scale language model 511, the determination unit 258 determines that the special term is included in the question data. Then, the process proceeds to step S1020, which will be described later. In the case where the term information does not include a term that matches the term included in the extraction result provided by the large-scale language model 511, the determination unit 258 determines that the special term is not included in the question data. Then, the process proceeds to step S1021, which will be described later.

The third determination process has been described above. In the third determination process, as in the second determination process, the determination of whether the special term is included in the question data is flexibly performed.

In the present embodiment, a determination process may be performed by combining the first determination process with the second determination process or the third determination process. Specifically, for example, the second determination process or the third determination process may be performed after the first determination process is performed. Then, a determination of whether the special term is included in the question data is performed according to the determination results of the two types of determination processes. By combining the determination processes in this way, a determination of whether the special term is included in the question data can be performed with high accuracy and flexibility.

In step S1020, in the case where it is determined that the special term is included in the question data, the information processing apparatus 200 appends, with the description appending unit 259, information indicating the meaning of the special term included in the question data to the question data. Specifically, the description appending unit 259 appends the value of the item “description” associated with the special term or the synonym included in the question data from the term information stored in the term dictionary DB 450, to the end of the question data as the information indicating the meaning of the special term.

In step S1021, the information processing apparatus 200 transmits, with the search request unit 252, to the second storage device 400, a search request for searching for a chunk that can serve as an information source for generating answer data to the question data.

Specifically, in the case where the query is acquired in step S1007 and it is determined that the special term is included in the question data, the search request unit 252 includes, in the query, the question data to which the description of the special term or the synonym of the special term is appended. In the case where the query is not acquired, that is, in the case where the conversation history information is not acquired in step S1004 and it is determined that the special term is included in the question data, the search request unit 252 transmits, to the second storage device 400, a search request including the question data obtained by appending the description to the question data input in step S1001.

In response to receiving the search request, the second storage device 400 searches, with the search unit 430, the chunk DB 415 of the second storage device 400 in step S1022 and transmits the chunk obtained as the search result to the information processing apparatus 200 in step S1023.

After acquiring the chunk that is the search result with the information acquisition unit 254, in step S1024, the information processing apparatus 200 generates, with the prompt generation unit 255, a prompt requesting generation of answer data to the question data using the chunk, which is the search result, as an information source. In step S1025, the prompt is transmitted to the server apparatus 500.

The prompt generated at this point includes the question data. In addition, in the case where it is determined that the special term is included in the question data, the prompt generated at this point includes the question data to which the description of the special term or the synonym of the special term is appended.

In response to receiving the prompt, in step S1026, the server apparatus 500 inputs, with the input unit 520, the prompt to the large-scale language model 511, and transmits, with the output unit 530, the response data output from the large-scale language model 511 to the information processing apparatus 200 as answer data.

In step S1027, after acquiring the answer data with the response acquisition unit 262, the information processing apparatus 200 outputs, with the information output unit 260, the acquired answer data to the terminal apparatus 600. In step S1028, the terminal apparatus 600 causes, with the display control unit 650, the answer data to be displayed on the display 618. At this time, the display control unit 650 causes the answer data to be displayed on the display 618 in association with the question data.

In step S1029, the information processing apparatus 200 transmits, with the information output unit 260, a request for storing the conversation history information including the question data received in step S1001 and the answer data output to the terminal apparatus 600 in step S1027 to the first storage device 300. The request for storing the conversation history information at this point includes the tenant ID of the tenant to which the user of the terminal apparatus 600 belongs.

In step S1030, in the first storage device 300, the storage unit 340 stores new conversation history information in the conversation history DB 310. Specifically, the storage unit 340 may add a new conversation ID and a new date and time to the question data, the answer data, and the tenant ID acquired from the information processing apparatus 200, and store a set of these pieces of information in the conversation history DB 310 as conversation history information. In the present embodiment, the conversation history DB 310 is updated in this way.

In the present embodiment, a configuration can be adopted in which a prompt does not include a chunk (a part of a file). In other words, in the present embodiment, information used for generating answer data to the question data can be acquired without transmitting a file itself.

In this case, the second storage device 400 holds index information that includes metadata extracted from the chunks obtained by dividing a file, such as a feature word, a summary, or a vector expression.

In this case, in addition, in step S1022 of FIG. 10, the search result, which is obtained by searching the index information held by the second storage device 400 based on the search request including the question data, is acquired and transmitted to the information processing apparatus 200.

The search result acquired at this point includes pieces of information that is highly relevant to the question data, such as a summary, a list of keywords, or an embedded vector.

In FIG. 10, the prompt generation unit 255 generates a prompt including the pieces of information acquired as the search result and the question data in step S1024, and outputs the prompt generated by the prompt output unit 256 to the server apparatus 500 in step S1025. The prompt output to the server apparatus 500 at this point does not include the file body itself.

Specifically, for example, it is assumed that question data indicating “What is the warranty period of a product X?” is input in step S1001, the determination unit 258 determines that the “warranty period” is a special term, and the meaning of the special term “warranty period” is a “product warranty policy.” In this case, in the process of searching in step S1022, the index information is searched using, as a search key, question data to which a description is appended, namely “What is the warranty period of a product X?” + “product warranty policy.”

The information processing apparatus 200 acquires a relevant summary from the index information relating to the “product warranty policy” as a search result. Further, the information processing apparatus 200 generates, with the prompt generation unit 255, a prompt including the question data to which a description is appended and the summary of the product warranty policy, and outputs, with the prompt output unit 256, the prompt to the server apparatus 500. The information processing apparatus 200 generates, as answer data to the prompt, answer data such as “The warranty period of the product X is one year.” and transmits the answer data to the terminal apparatus 600.

In this way, according to the present embodiment, the information used for generating the answer data can be acquired without transmitting the file itself.

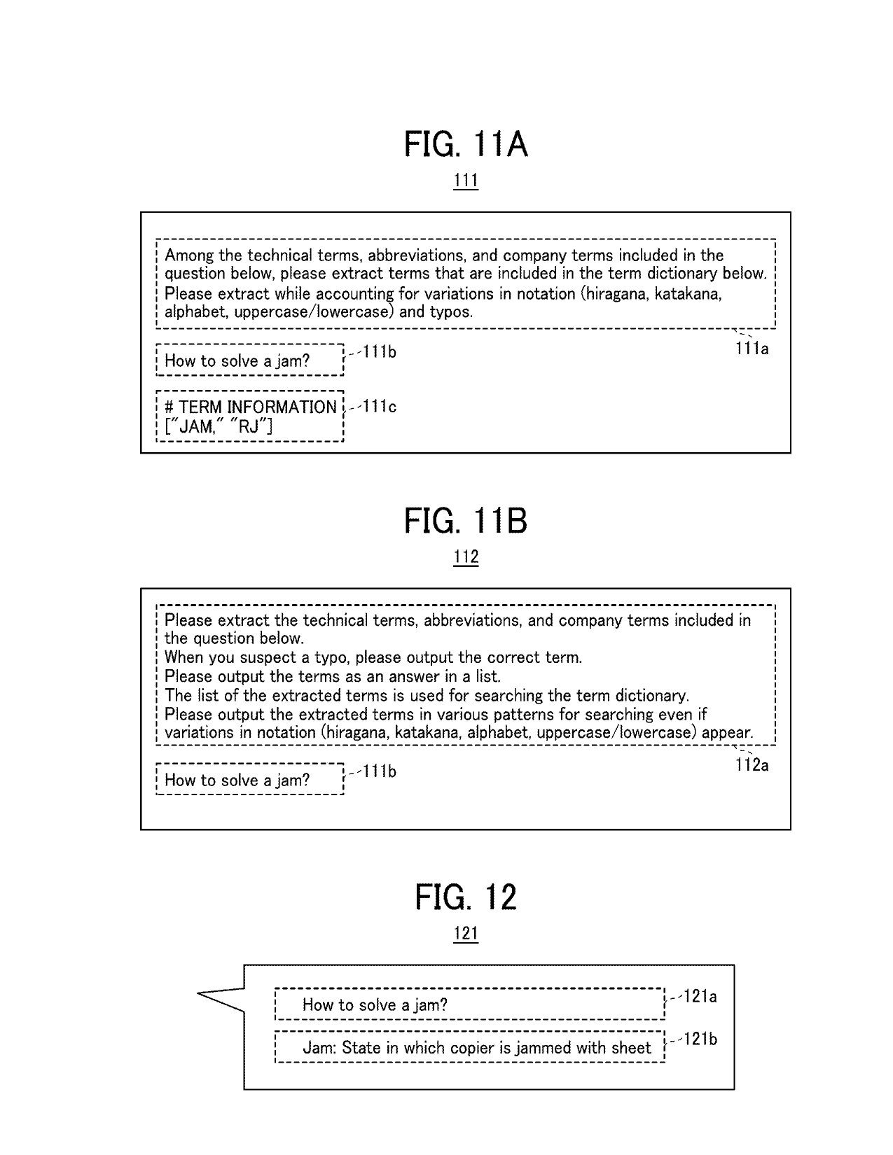

With reference to FIGS. 11A and 11B, the prompts generated by the prompt generation unit 255 in steps S1012 and S1015 of FIG. 10 are described below. FIGS. 11A and 11B are first diagrams each illustrating the prompt in the first embodiment.

A prompt 111 illustrated in FIG. 11A is an example of the prompt generated in step S1012 of FIG. 10. The prompt 111 includes text data 111a, text data 111b, and text data 111c. The text data 111a is an example of text data for requesting extraction of the special term from the question data and requesting reliable extraction of the special term included in the term information from the question data. The text data 111b is an example of the question data input from the terminal apparatus 600.

The text data 111c is an example of the term information acquired by the information acquisition unit 254. In the present embodiment, by including the term information in the prompt 111, the accuracy of extracting the special term from the question data is increased. When the term information acquired by the information acquisition unit 254 is longer than the length of the token allowed in the generative AI implemented by the server apparatus 500, the text data 111a may be divided and processed.

A prompt 112 illustrated in FIG. 11B is an example of the prompt generated in step S1015 of FIG. 10. The prompt 112 includes text data 112a and the text data 111b. The text data 112a is an example of text data for requesting extraction of the special term from the question data.

In the present embodiment, by generating the prompt 112 in this way, the length of the prompt can be shortened. Accordingly, the cost of using the generative AI implemented by the server apparatus 500 is reduced.

With reference to FIG. 12, question data to which a description of the special term is appended is described below. FIG. 12 is a diagram illustrating an example of the question data to which a description of the special term is appended, according to the first embodiment.

Text data 121 illustrated in FIG. 12 includes text data 121a and text data 121b. The text data 121a is question data input from the terminal apparatus 600. The text data 121b is text data indicating the description of the special term included in the text data 121a.

In FIG. 12, it can be seen that the text data 121a indicating “How to solve a jam?” is input as the question data, and the text data 121b indicating “A state in which the copier is jammed with a sheet.” is appended to the question data as the description of the “jam” that is the special term extracted from the question data.

In other words, the text data 121 of the present embodiment is an example of question data to which a description is appended, which is the question data to which the description of the special term included in the question data is appended. In the following description, the question data to which the description of the special term is appended may be referred to as question data with description.

According to the technique in the related art, when the input information includes a special term used in a specific organization or industry, the content of the question indicated by the input information may not be correctly understood, and an appropriate answer may not be obtained.

In the present embodiment, as described above, by transmitting the search request including the question data with description to the second storage device 400 and searching the chunk DB 415, a chunk serving as an information source for an answer to the question can be appropriately extracted.

Further, in the present embodiment, by including the question data with description in the prompt requesting generation of an answer to the question, the accuracy of the answer is increased.

In the present embodiment, the description of the special term included in the question data may be appended to one of the search request for searching for a chunk that can be the information source in generating answer data and the prompt requesting generation of an answer to the question. In the present embodiment, it is sufficient that the prompt requesting generation of an answer to the question includes the question data with description. The information indicating the meaning of the special term may not be appended to the question data included in the search request for searching for a chunk that can be the information source in generating answer data. It is assumed that the information indicating the meaning of the special term included in the question data is not appended to the prompt requesting generation of an answer to the question. In the present embodiment, even such a case, when the information indicating the meaning of the special term is included in the search request for searching for a chunk that can be the information source in generating answer data, a chunk suitable for generating the answer data to the question data including the special term can be acquired as an information source.

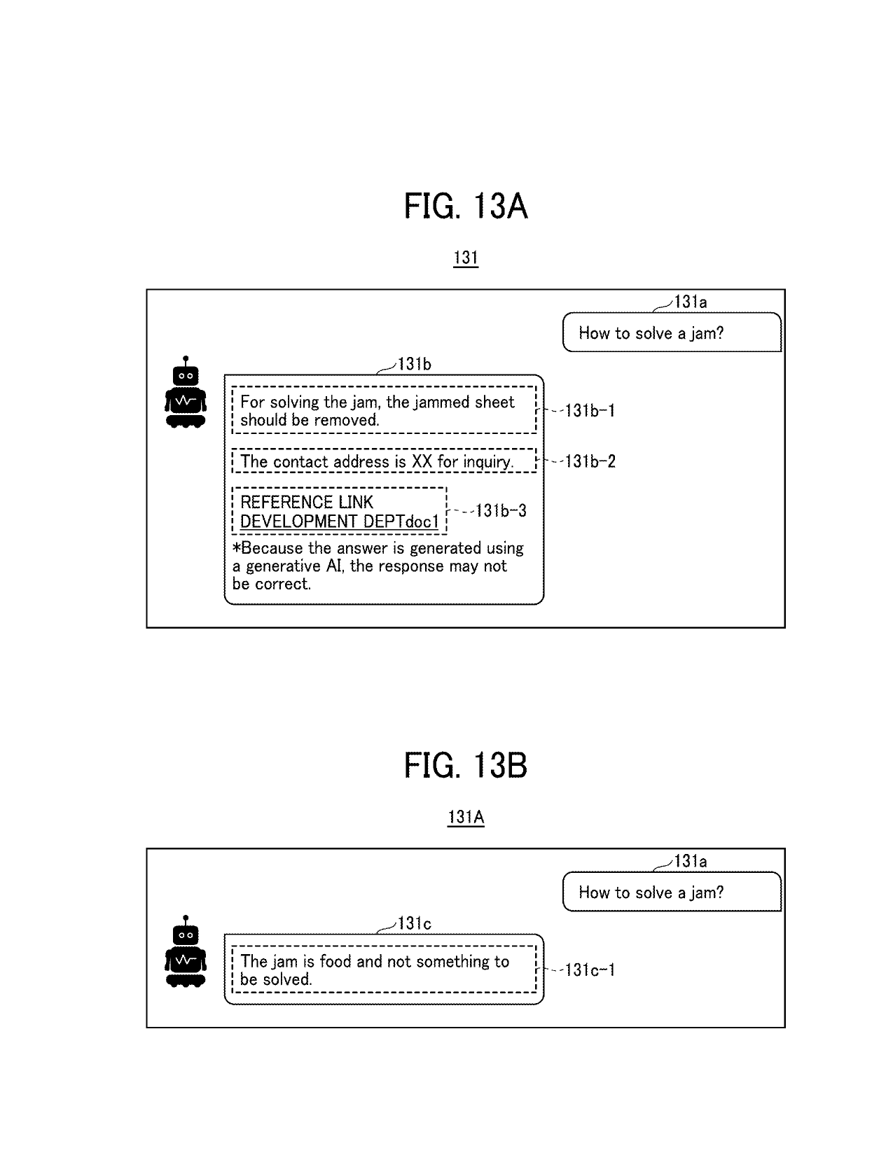

With reference to FIGS. 13A and 13B, display examples displayed on the display of the terminal apparatus 600 are described below. FIGS. 13A and 13B are first diagrams each illustrating a display example displayed on the display of the terminal apparatus 600, according to the first embodiment.

A screen 131 illustrated in FIG. 13A is an example of the screen displayed on the display of the terminal apparatus 600 in step S1028 of FIG. 10. In other words, the screen 131 is an example of a screen on which the answer data output by the server apparatus 500 is presented in response to the question data input from the terminal apparatus 600.

The screen 131 includes a display field 131a and a display field 131b. In the display field 131a, the question data indicating “How to solve a jam?” input by the user of the terminal apparatus 600 is displayed. In the display field 131b, in addition to answer data 131b-1 output from the chat system 100, text data 131b-2 and a link 131b-3 are displayed.

In the example of FIG. 13A, the question data displayed in the display field 131a includes the term “jam,” which is a special term. Accordingly, the information processing apparatus 200 acquires a chunk as a result of searching the chunk DB 415 using, as a search key, the question data with description, which is the question data to which the description indicating “A state in which the copier is jammed with a sheet.” is appended. Then, the information processing apparatus 200 transmits a prompt requesting generation of answer data using the chunk as an information source to the server apparatus 500, and acquires the answer data from the server apparatus 500.

Accordingly, the answer indicated by the answer data 131b-1 displayed in the display field 131b is an answer generated based on the interpretation that the meaning of the special term “jam” is “A state in which the copier is jammed with a sheet.”

The text data 131b-2 includes information indicating a contact address for the user of the terminal apparatus 600 to make a further inquiry. The information indicating the contact address may be, for example, an e-mail address or a telephone number. The information indicating the contact address may be stored in, for example, the user information DB 420. Specifically, the user information DB 420 can store information indicating a task assigned to each user in association with the user ID of each user.

When transmitting the answer data to the terminal apparatus 600, the information processing apparatus 200 may acquire the e-mail address of the user in charge of the task corresponding to the question indicated by the question data and transmit the e-mail address to the terminal apparatus 600 together with the answer data. In this way, by displaying the contact address together with the answer data, the convenience for the user is increased.

The link 131b-3 is a link for displaying information relating to the content indicated by the question data or the answer data. The link 131b-3 in the present embodiment may alternatively be information indicating the storage location of a file including the chunk serving as the information source of the answer data displayed in the display field 131b. In this case, in response to receiving an operation to select the link 131b-3, the information processing apparatus 200 causes the terminal apparatus 600 to display the file including the chunk serving as the information source of the answer data.

By contrast, a screen 131A illustrated in FIG. 13B is a display example displayed on the display of the terminal apparatus 600 in the case where the present embodiment is not applied. On the screen 131A, the meaning of the special term “jam” included in the question data displayed in the display field 131a is interpreted as the meaning of a general term. Thus, in the display field 131c included in the screen 131A, answer data 131c-1 indicating “Jam is food and not something to be solved,” which is an inappropriate content, is displayed.

In this way, in the present embodiment, the second storage device 400 is searched using, as a search key, information to which the description indicating the meaning of the included special term is appended, and the chunk extracted as the search result serves as an information source of the answer.

Accordingly, according to the present embodiment, even when the question data includes an abbreviation used in the tenant to which the user belongs or a technical term used in the industry to which the tenant belongs, the answer data to the question data can be output with high accuracy.

Further, according to the present embodiment, since the term information is referred to and the description of the special term is appended to the question data each time question data is input, the management of the term information stored in the term dictionary DB 450 of the second storage device 400 and the management of the files stored in the file DB 410 are performed independently. Accordingly, in the present embodiment, when the term dictionary DB 450 is updated, no other process is required. Thus, in the present embodiment, the term information stored in the term dictionary DB 450 can be easily updated.

### Second Embodiment

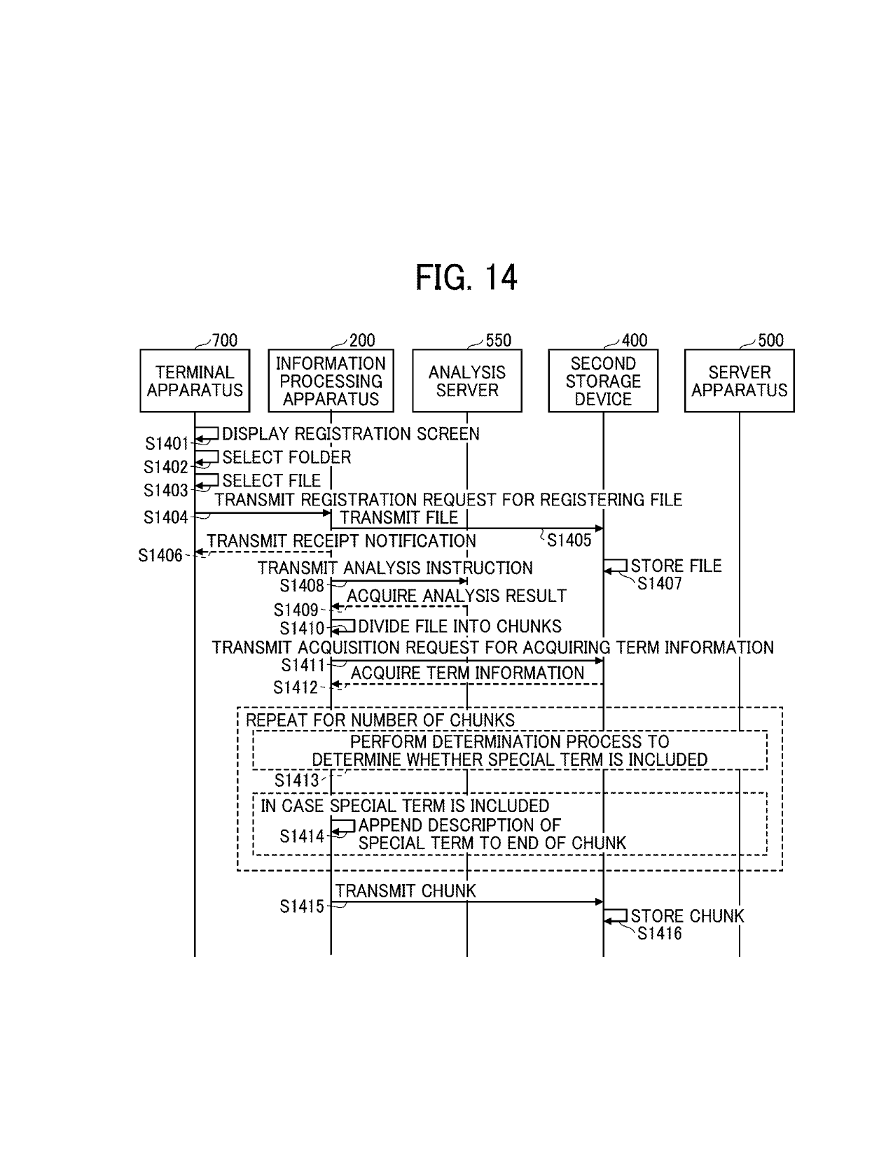

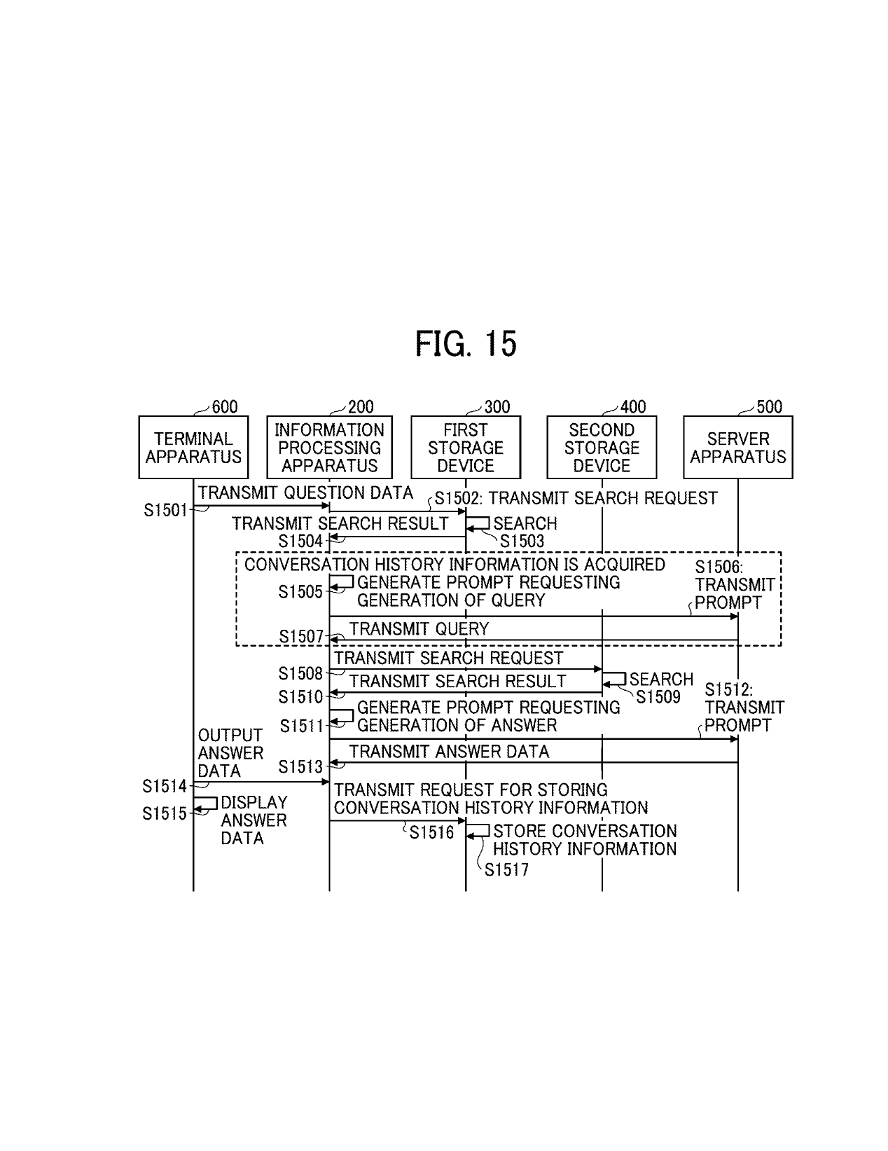

The chat system according to a second embodiment is described below with reference to FIGS. 14 and 15. The second embodiment differs from the first embodiment in that information indicating the meaning of a special term is appended to a chunk to be stored in the chunk DB 415 of the second storage device 400. In the following description of the second embodiment, differences from the first embodiment are described. The same reference numerals are given to the same or corresponding functions or configurations as those of the first embodiment, and redundant descriptions thereof are omitted or simplified appropriately.

In the present embodiment, when a file selected on the terminal apparatus 700 is stored in the second storage device 400, the information processing apparatus 200 appends the description of a special term to a chunk that is information obtained by dividing the file into predetermined units. With reference to FIG. 14, the operation performed by the file DB 410 to store the file in the chat system 100 according to the present embodiment is described below.

FIG. 14 is a first sequence diagram illustrating the operation performed by the chat system 100 according to the second embodiment. In step S1401, the terminal apparatus 700 of the chat system 100 according to the present embodiment causes, with the display control unit 750, a registration screen for registering a file to be displayed. In step S1402, the terminal apparatus 700 selects, with the input reception unit 740, a folder in which the file is to be stored. In step S1403, the terminal apparatus 700 receives, with the input reception unit 740, the selection of the file to be stored in the folder. In step S1404, the terminal apparatus 700 transmits (uploads), with the communication control unit 730, the selected file and a registration request for registering the file in the second storage device 400 to the information processing apparatus 200.

In step S1405, when receiving the file together with the registration request with the input reception unit 251, the information processing apparatus 200 transmits, with the information output unit 260, the received file to the second storage device 400. In step S1406, the information processing apparatus 200 transmits, with the information output unit 260, a receipt notification indicating that the file has been received to the terminal apparatus 700. In step S1407, the second storage device 400 stores, with the storage unit 440, the file in the selected folder in the file DB 410.

In step S1408, the information processing apparatus 200 transmits an analysis instruction to divide the file acquired in step S1404 into chunks to the analysis server 550. In step S1409, the information processing apparatus 200 acquires the analysis result from the analysis server 550. The analysis server 550 according to the present embodiment can also analyze whether the file contains an object such as an image or a table. In this case, when the file contains an object other than text data, the analysis server 550 transmits an analysis result that allows chunk division to the information processing apparatus 200.

In step S1410, the information processing apparatus 200 divides, with the dividing unit 261, the file received in step S1404 into chunks.

In step S1411, the information processing apparatus 200 transmits, with the information acquisition unit 254, an acquisition request for acquiring term information to the second storage device 400. In step S1412, the information processing apparatus 200 acquires, with the information acquisition unit 254, the term information stored in the term dictionary DB 450 from the second storage device 400.

The information processing apparatus 200 repeatedly performs, with the determination unit 258, the processes in steps S1413 to S1415 for each chunk divided in step S1410.

When the term information is acquired in step S1412, in step S1413, the information processing apparatus 200 performs a determination process to determine whether the special term included in the term information is included in each chunk obtained by dividing the file in step S1410.

The determination process performed in step S1413 is substantially the same as the determination process described in steps S1010 to S1019 of FIG. 10, except that the question data in the determination process described in steps S1010 to S1019 of FIG. 10 is replaced with the chunk.

In other words, the determination process according to the present embodiment includes the first determination process in which the term search unit 257 searches for a chunk based on the special term and the synonym included in the term information, and it is determined that the special term is included in the chunk when the special term is extracted from the chunk. The determination process according to the present embodiment also includes the second determination process in which the prompt generation unit 255 generates a prompt requesting extraction of the special term from the chunk and transmits the prompt to the server apparatus 500, and it is determined whether the special term is included in the chunk according to the response from the server apparatus 500. Further, the determination process of the present embodiment includes the third determination process to perform both the first determination process and the second determination process described above.

When it is determined in the determination process of step S1413 that the special term is not included in the chunk, the information processing apparatus 200 proceeds to step S1415, which will be described later.

By contrast, when it is determined in the determination process of step S1413 that the special term is included in the chunk, in step S1414, the information processing apparatus 200 appends, with the description appending unit 259, the description of the special term included in the chunk to the chunk. Specifically, the description appending unit 259 appends the value of the item “description” associated with the special term or the synonym included in the chunk from the term information stored in the term dictionary DB 450, to the end of the chunk as information indicating the meaning of the special term. In the following description, the chunk to which the description of the special term is appended may be referred to as a chunk with description.

In step S1415, the information processing apparatus 200 transmits, with the information output unit 260, the chunk or the chunk with description to the second storage device 400 together with the registration request for registering the chunk. In other words, the information output unit 260 outputs information indicating the meaning of the special term included in the file output by the large-scale language model 511 to the second storage device 400 in association with the file.

In step S1416, the second storage device 400 stores, with the storage unit 440, the received chunk in the chunk DB 415.

With reference to FIG. 15, the operation performed by the chat system 100 in the case where the question data is input from the terminal apparatus 600 in the chat system 100 according to the present embodiment is described below.

FIG. 15 is a second sequence diagram illustrating the operation performed by the chat system 100 according to the second embodiment.

The processes in steps S1501 to S1507 of FIG. 15 are substantially the same as those in steps S1001 to S1007 of FIG. 10, and the descriptions thereof are omitted.

In step S1508, the information processing apparatus 200 transmits, with the search request unit 252, to the second storage device 400, a search request for searching for a chunk that can serve as an information source in generating answer data to the question data.

Specifically, when the query is acquired in step S1507, the search request unit 252 transmits, to the second storage device 400, the search request using the query as a search key. When the query is not acquired, that is, when the conversation history information is not acquired in step S1504, the search request unit 252 transmits the search request including the question data input in step S1501 to the second storage device 400. The search request may include the tenant ID.

In response to receiving the search request, the second storage device 400, with the search unit 430, searches the chunk DB 415 in step S1509 and transmits a chunk obtained as a search result to the information processing apparatus 200 in step S1510.

After acquiring the chunk that is the search result with the information acquisition unit 254, in step S1511, the information processing apparatus 200 generates, with the prompt generation unit 255, a prompt requesting generation of answer data to the question data using the chunk, which is the search result, as an information source. In step S1512, the prompt is transmitted to the server apparatus 500. Then, the process proceeds to step S1513.

The processes in steps S1513 to S1517 of FIG. 15 are substantially the same as those in steps S1026 to S1030 of FIG. 10, and the descriptions thereof are omitted.

In the present embodiment, when a file contains a special term, the folder is divided into chunks, and then a chunk that includes the special term is stored in the chunk DB 415 as a chunk with description.

Accordingly, in the present embodiment, when a special term is included in the question data input in step S1501, a chunk with description, which is a chunk to which the description of the special term included in the question data is appended, is acquired as a search result obtained by searching the chunk DB 415. Thus, in the present embodiment, when a special term is included in the question data, the prompt to be transmitted to the server apparatus 500 requests generation of an answer using the chunk to which the description of the special term is appended as an information source.

As a result, according to the present embodiment, even when a special term is included in the question data, the answer data generated based on the interpretation that the meaning of the special term is appropriately interpreted can be acquired from the server apparatus 500. Thus, the accuracy of the answer to the question is increased.

In the present embodiment, the determination process to determine whether a special term is included in the question data input in step S1501 of FIG. 15 is not performed. In another embodiment, however, the determination process may be performed.

In the chat system 100 according to the present embodiment, the processes illustrated in FIG. 10 are performed as operations when question data is input from the terminal apparatus 600.

In other words, when a special term is included in the input question data, the information processing apparatus 200 according to the present embodiment may append the description of the special term to the question data to generate question data with description and transmit a search request including the question data with description to the second storage device 400.

The information processing apparatus 200 may acquire, from the second storage device 400, a chunk with description, which is a chunk to which the description of the special term included in the question data is appended, and transmit, to the server apparatus 500, a prompt requesting generation of answer data to the question data with description using the chunk with description as an information source.

In the present embodiment, as described above, the chunk DB 415 storing the chunk with description, which is the chunk to which the description of the special term is appended, is searched using the question data with description, which is the question data to which the description of the special term is appended. Thus, a chunk appropriate as an information source of the answer can be obtained as the search result. Accordingly, by combining the second embodiment with the first embodiment, the accuracy of an answer to a question including a special term is further increased.

### Third Embodiment

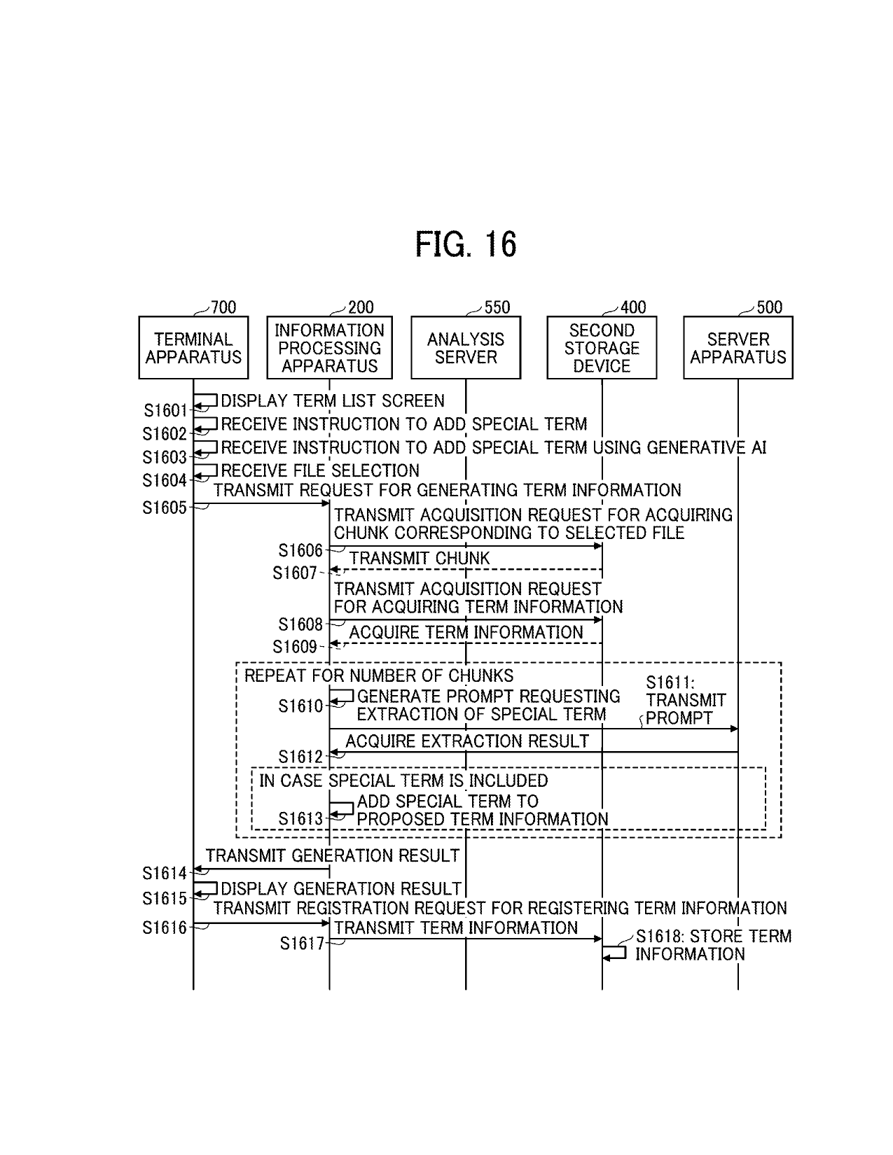

The chat system according to a third embodiment is described below with reference to FIGS. 16 to 23. The third embodiment differs from the first and second embodiments in that term information that includes a special term included in a file stored in the file DB 410 is automatically generated and stored in the term dictionary DB 450. In the following description of the third embodiment, differences from the first and second embodiments are described. The same reference numerals are given to the same or corresponding functions or configurations as those of the first and second embodiments, and redundant descriptions thereof are omitted or simplified appropriately.

With reference to FIG. 16, the operation performed by the chat system 100 when a special term included in a file stored in the file DB 410 is stored in the term dictionary DB 450 as term information is described below.

FIG. 16 is a first sequence diagram illustrating the operation performed by the chat system 100 according to the third embodiment.

In step S1601, the terminal apparatus 700 causes, with the display control unit 750, a term list screen presenting a list of special terms to be displayed in the chat system 100 according to the present embodiment. In step S1602, the terminal apparatus 700 receives, with the input reception unit 740, an operation for instructing addition of a special term. In step S1603, the terminal apparatus 700 receives, with the input reception unit 740, an operation for instructing addition of a special term using the generative AI.

In step S1604, the terminal apparatus 700 causes, with the display control unit 750, a list of files stored in the file DB 410 to be displayed, and receives a selection of a file from which the special term is extracted.

In step S1605, the terminal apparatus 700 transmits, with the communication control unit 730, a generation request for generating term information based on the selected file to the information processing apparatus 200. The generation request transmitted to the information processing apparatus 200 at this point may include a tenant ID and information for identifying the selected file. The information for identifying the file may be, for example, the name of the file.

In step S1606, when receiving the generation request for generating term information with the input reception unit 251, the information processing apparatus 200 transmits, with the information acquisition unit 254, an acquisition request for acquiring a chunk corresponding to the selected file to the second storage device 400. In step S1607, the information processing apparatus 200 acquires, with the information acquisition unit 254, the chunk corresponding to the selected file.

In step S1608, the information processing apparatus 200 transmits, with the information acquisition unit 254, an acquisition request for acquiring term information to the second storage device 400. In step S1609, the information processing apparatus 200 acquires, with the information acquisition unit 254, the term information stored in the term dictionary DB 450 from the second storage device 400.

Subsequently, the information processing apparatus 200 repeatedly performs the processes in steps S1610 to S1613 for the number of chunks obtained in step S1607.

In step S1610, the information processing apparatus 200 generates, with the prompt generation unit 255, a prompt requesting extraction of a special term other than the special term included in the term information from the chunk. The prompt generated in step S1610 will be described in detail later.

In step S1611, the information processing apparatus 200 transmits, with the prompt output unit 256, the generated prompt to the server apparatus 500. In step S1612, the information processing apparatus 200 acquires, with the response acquisition unit 262, the extraction result output as response data to the prompt from the server apparatus 500.

In the case where the special term is not included in the extraction result acquired from the server apparatus 500, the information processing apparatus 200 proceeds to step S1614, which will be described later. By contrast, in the case where the special term is included in the extraction result acquired from the server apparatus 500, in step S1613, the information processing apparatus 200 add, with the information acquisition unit 254, the extracted special term to a proposal of the term information to be output, as the generation result of the term information, to the terminal apparatus 700.

In step S1614, the information processing apparatus 200 transmits, with the information acquisition unit 254, information indicating the generation result of the term information to the terminal apparatus 700.

In step S1615, the terminal apparatus 700 causes, with the display control unit 750, the information indicating the generation result of the term information to be displayed. The generation result of the term information displayed at this point may be corrected by the user of the terminal apparatus 700 to obtain a correction result. In addition, the special term included in the generation result of the term information displayed at this point is a candidate of the special term to be stored in the term dictionary DB 450.

In step S1616, when receiving an operation for instructing registration of the term information with the input reception unit 740, the terminal apparatus 700 transmits, with the communication control unit 730, a registration request for registering the term information to the information processing apparatus 200.

In step S1617, in response to receiving the registration request for registering the term information, the information processing apparatus 200 transmits, with the information acquisition unit 254, the term information to the second storage device 400 together with the registration request. In step S1618, the second storage device 400 receives the registration request for registering the term information and stores the term information in the term dictionary DB 450.

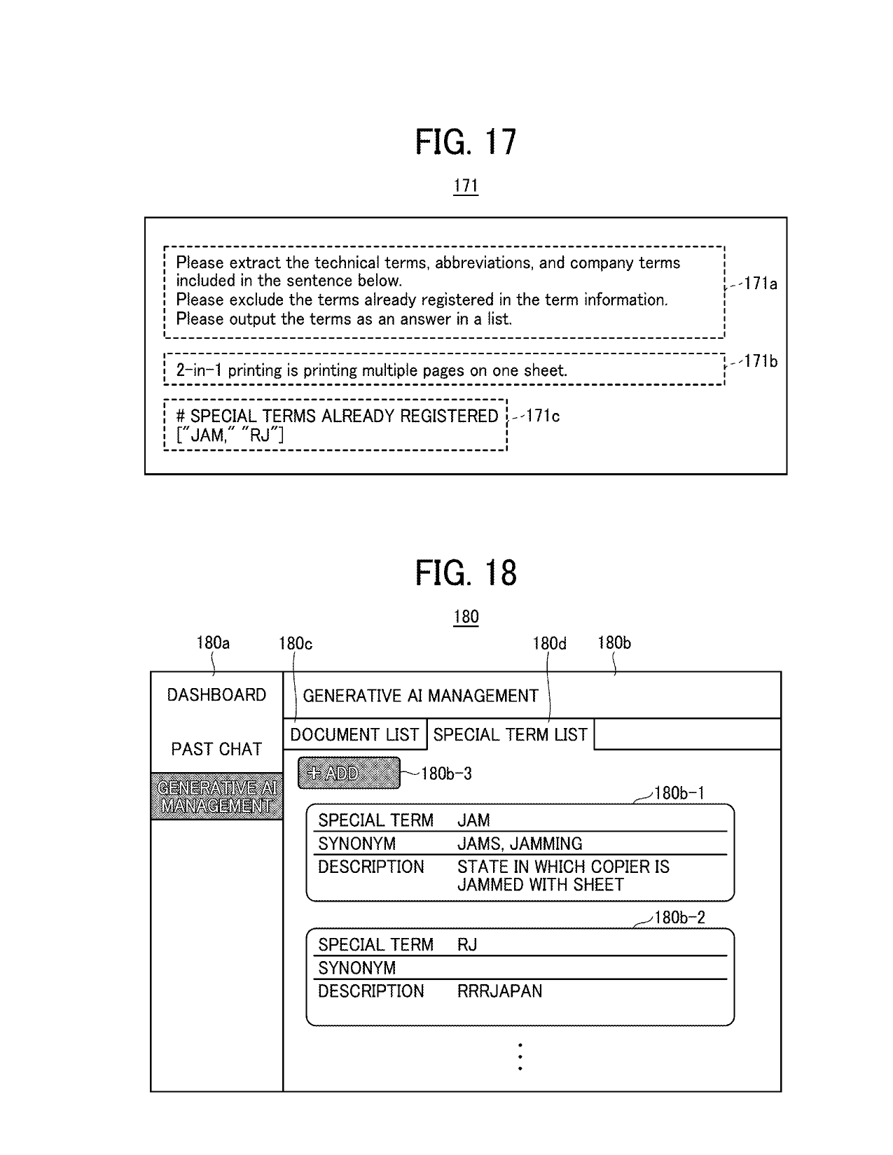

With reference to FIG. 17, the prompt generated in step S1610 of FIG. 16 is described below. FIG. 17 is a diagram illustrating an example of the prompt generated in the third embodiment.

A prompt 171 illustrated in FIG. 17 includes text data 171a, text data 171b, and text data 171c. The text data 171a is text data requesting extraction of special terms other than the special terms included in the term information stored in the term dictionary DB 450 from the chunk included in the prompt 171.

The text data 171b is an example of the chunk acquired in step S1607. The text data 171c is an example of the term information acquired in step S1609.

According to the present embodiment, by including the chunk and the term information in the prompt 171 as described above, the extraction of special terms other than the special terms included in the term information from the chunk can be requested to the generative AI implemented by the server apparatus 500.

With reference to FIGS. 18 to 21, display examples displayed on the display of the terminal apparatus 700 are described below.

FIG. 18 is a first diagram illustrating a display example displayed on the display of the terminal apparatus 700 according to the third embodiment. A screen 180 illustrated in FIG. 18 is an example of the screen displayed on the display of the terminal apparatus 700 in step S1601 of FIG. 16.

The screen 180 includes a display field 180a and a display field 180b. In the display field 180a, a list of management menus of the chat system 100 may be displayed. In the example of FIG. 18, a menu relating to the processing using the generative AI implemented by the server apparatus 500 is selected in the display field 180a.

The display field 180b includes a tab 180c and a tab 180d. The tab 180c is a tab for displaying, for example, a list screen of files stored in the file DB 410 in the display field 180b. The tab 180d is a tab for displaying a list of special terms stored in the term dictionary DB 450 in the display field 180b.

In the example of FIG. 18, the tab 180d is selected, and the list of special terms stored in the term dictionary DB 450 is displayed in the display field 180b. The display field 180b illustrated in FIG. 18 includes a display field 180b-1, a display field 180b-2, and an operation button 180b-3. In the display field 180b-1, the term information including the special term “jam” is displayed. In the display field 180b-2, the term information including the special term “RJ” is displayed.

The operation button 180b-3 is used to display a screen for adding term information. In response to receiving an operation for selecting the operation button 180b-3 on the screen 180, the terminal apparatus 700 causes the screen 180 to transition to the screen for adding term information.

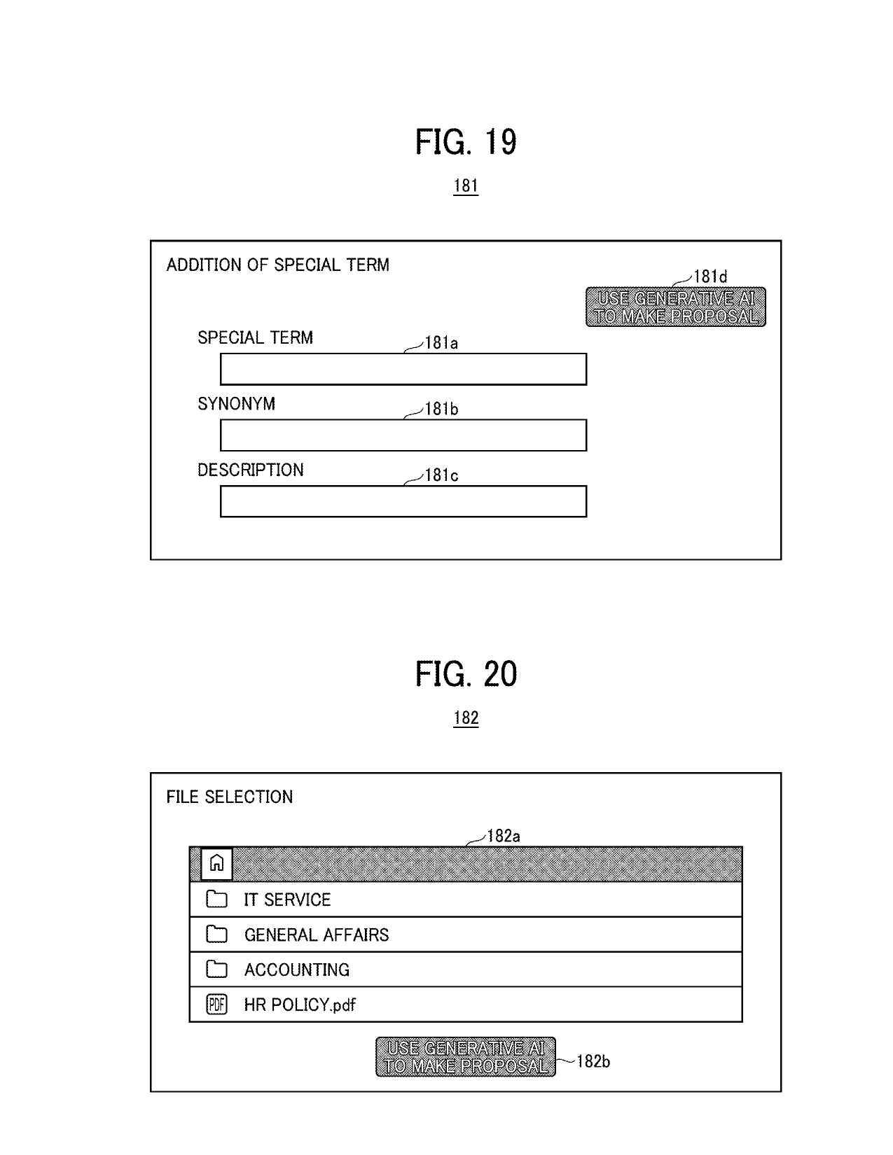

FIG. 19 is a second diagram illustrating a display example displayed on the display of the terminal apparatus 700 according to the third embodiment. A screen 181 illustrated in FIG. 19 is an example of the screen displayed on the display of the terminal apparatus 700 when the operation button 180b-3 is operated on the screen 180 illustrated in FIG. 18 in step S1602 of FIG. 16.

The screen 181 is an example of the screen for adding term information. The screen 181 includes an input field 181a, an input field 181b, an input field 181c, and an operation button 181d. The input fields 181a, 181b, and 181c are input fields for the user of the terminal apparatus 700 to input a special term, a synonym, and a description, respectively.

The operation button 181d is an operation button for instructing addition of a special term using the generative AI. In response to receiving an operation for selecting the operation button 181d on the screen 181, the terminal apparatus 700 according to the present embodiment causes the screen 181 to transition to a screen for selecting a file.

FIG. 20 is a third diagram illustrating a display example displayed on the display of the terminal apparatus 700 according to the third embodiment. A screen 182 illustrated in FIG. 20 is an example of the screen displayed on the display of the terminal apparatus 700 when the operation button 181d is operated on the screen 181 illustrated in FIG. 19 in step S1603 of FIG. 16.

The screen 182 illustrated in FIG. 20 includes a display field 182a and an operation button 182b. In the display field 182a, a list of files from which a special term is to be extracted is displayed. The list of files displayed at this point may be a list of file names of files stored in the file DB 410.

The operation button 182b is an operation button for transmitting a generation request for generating term information based on the file selected in the display field 182a to the information processing apparatus 200. In FIG. 20, for example, in response to receiving an operation of selecting the operation button 182b after the file name “IT service” is selected, the terminal apparatus 700 transmits a generation request for generating term information using the generative AI based on the file having the file name “IT service” to the information processing apparatus 200.

In response to receiving the term information generated by the generative AI as a generation result from the information processing apparatus 200, the terminal apparatus 700 displays the term information that is the generation result.

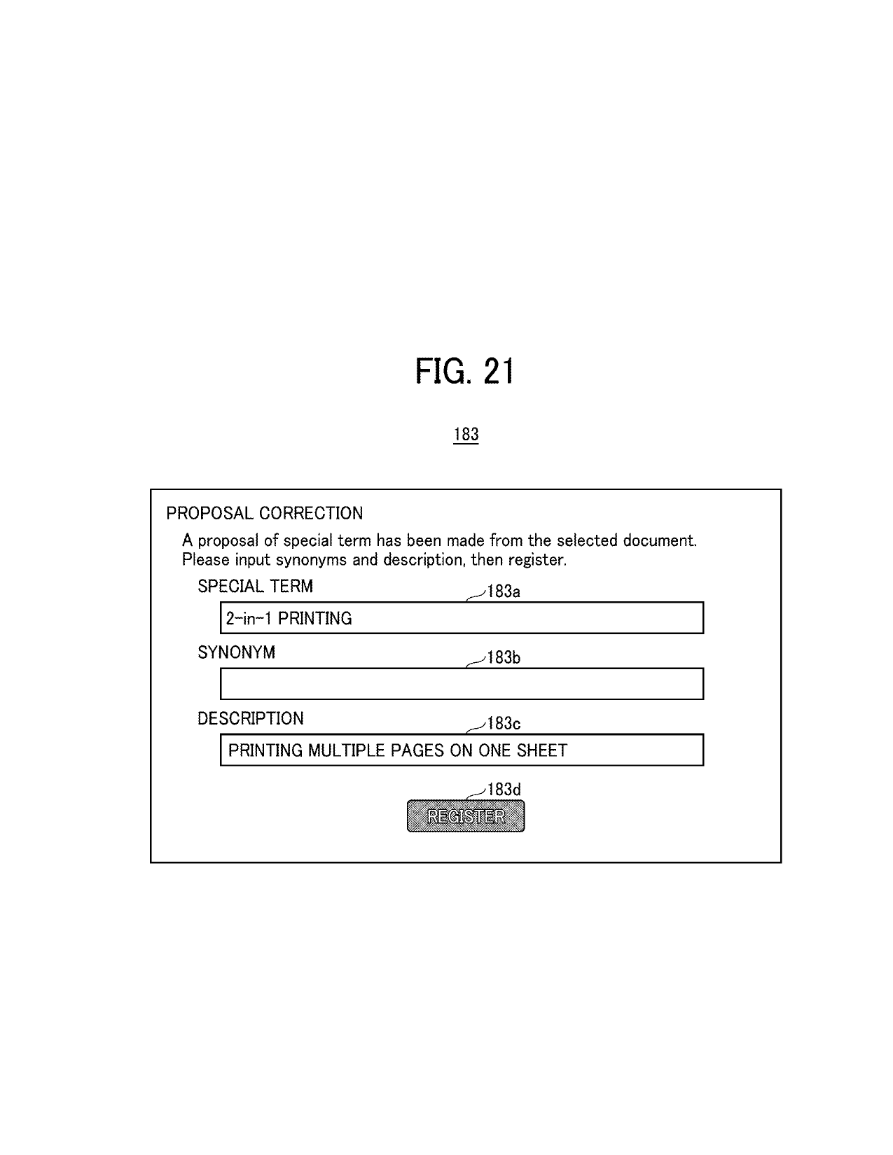

FIG. 21 is a fourth diagram illustrating a display example displayed on the display of the terminal apparatus 700 according to the third embodiment. A screen 183 illustrated in FIG. 21 is an example of the screen displayed on the display of the terminal apparatus 700 in step S1614 of FIG. 16. On the screen 183, a candidate generated by the generative AI for term information is displayed.

The screen 183 includes a display field 183a, a display field 183b, a display field 183c, and an operation button 183d. In the display fields 183a, 183b, and 183c, a candidate of a special term, a candidate of a synonym, and a candidate of description included in the candidate generated by the generative AI for the term information are displayed, respectively. The operation button 183d is an operation button for storing, as term information, the candidate for the term information, in which the candidate of a special term, the candidate of a synonym, and the candidate of description respectively displayed in the display fields 183a, 183b, and 183c are associated with one another, in the term dictionary DB 450.

In the example of FIG. 21, a term “2-in-1 printing” is extracted as a special term from the chunk, and text data indicating “printing multiple pages on one sheet” is extracted as description.

In addition, on the screen 183, a correction of information displayed in each of the display fields 183a, 183b, and 183c is received. Also, an input of information to any one of the display fields 183a, 183b, and 183c that have been displayed as blank fields is received.

For example, when the operation button 183d is operated after a synonym is input to the display field 183b that has been displayed as a blank field on the screen 183, term information associating “2-in-1 printing” and “printing multiple pages on one sheet” with the input synonym is stored in the term dictionary DB 450.

In the present embodiment, the term information can be generated using the generative AI as described above. Accordingly, for example, when a new file is stored in the file DB 410, the time and effort required for the administrator of the chat system 100 to manually input the term information can be eliminated.

In the present embodiment, the term information is generated by the generative AI implemented by the server apparatus 500. In another embodiment, however, the term information may be generated by another apparatus or a combination of two or more apparatuses. In the present embodiment, the process for generating term information can be performed using the server apparatus 500 and the information processing apparatus 200.

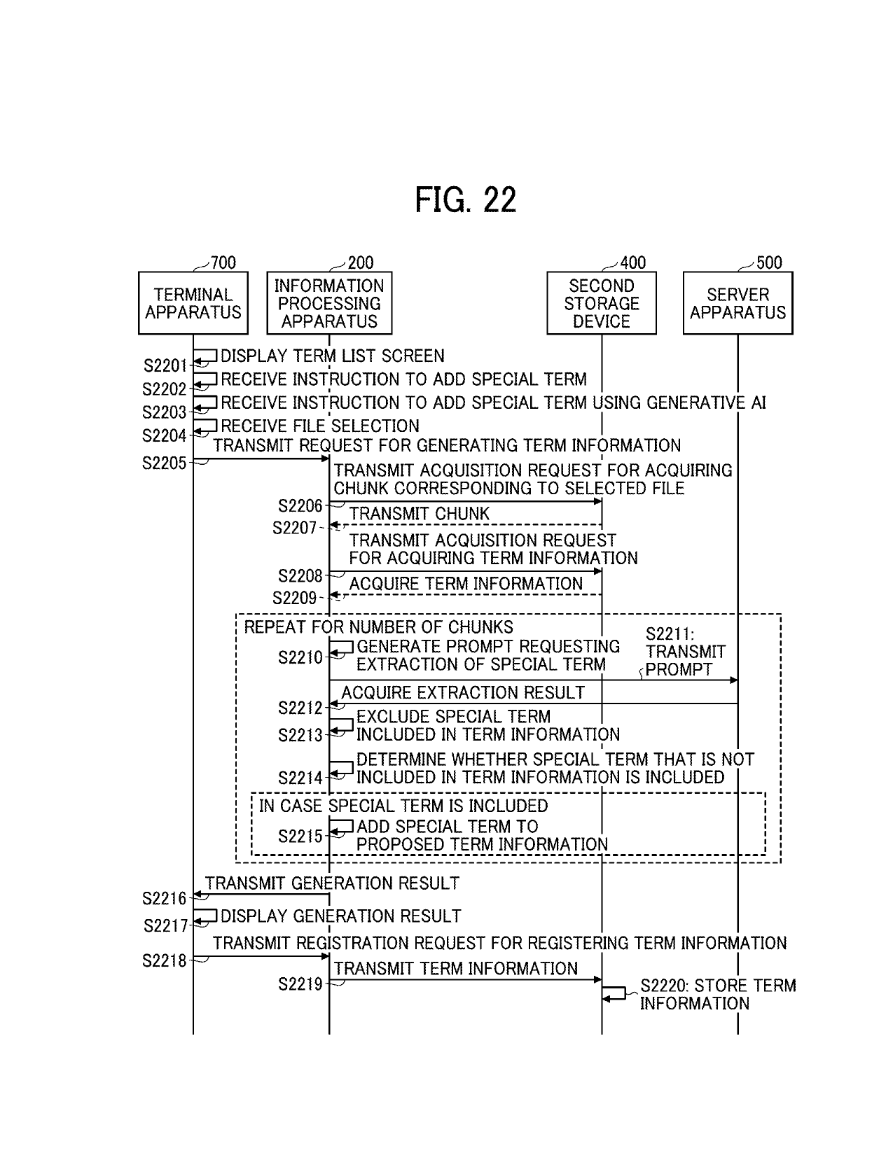

With reference to FIG. 22, the operation performed by the chat system 100 when the process for generating term information is performed using the server apparatus 500 and the information processing apparatus 200 is described below.

FIG. 22 is a second sequence diagram illustrating the operation performed by the chat system 100 according to the third embodiment.

The processes in steps S2201 to S2209 of FIG. 22 are substantially the same as those in steps S1601 to S1609 of FIG. 16, and the descriptions thereof are omitted.

In response to acquiring the term information in step S2209, in step S2210, the information processing apparatus 200 generates, with the prompt generation unit 255, a prompt requesting extraction of the special term included in the term information from the chunk. The prompt generated in step S2210 will be described in detail later.

In step S2211, the information processing apparatus 200 transmits, with the prompt output unit 256, the generated prompt to the server apparatus 500. In step S2212, the information processing apparatus 200 acquires, with the response acquisition unit 262, the extraction result output as response data to the prompt from the server apparatus 500.

In step S2213, the information processing apparatus 200 excludes the special term included in the term information from the special terms extracted by the server apparatus 500 from the chunk. Specifically, the information processing apparatus 200 searches, with the term search unit 257, the extraction result of the special terms extracted by the server apparatus 500 from the chunk, using the special term included in the term information as a search key, and excludes the special term included in the term information from the extraction result provided by the server apparatus 500.

In step S2214, the information processing apparatus 200, with the determination unit 258, determines whether any special term not included in the term information is present among the special terms extracted from the chunk.

Specifically, when a special term is present among the special terms extracted from the chunk even after the special term included in the term information is excluded from the extraction result provided by the server apparatus 500 in step S2213, the determination unit 258 determines that a special term not included in the term information is present among the special terms extracted from the chunk.

When it is determined that any special term not included in the term information is not present among the special terms extracted from the chunk, the information processing apparatus 200 proceeds to step S2216, which will be described later. When it is determined that a special term not included in the term information is present among the special terms extracted from the chunk, in step S2215, the information processing apparatus 200 adds the extracted special term to the proposal of the term information to be output, as the generation result of the term information, to the terminal apparatus 700.

The processes in steps S2215 to S2220 of FIG. 22 are substantially the same as those in steps S1613 to S1618 of FIG. 16, and the descriptions thereof are omitted.

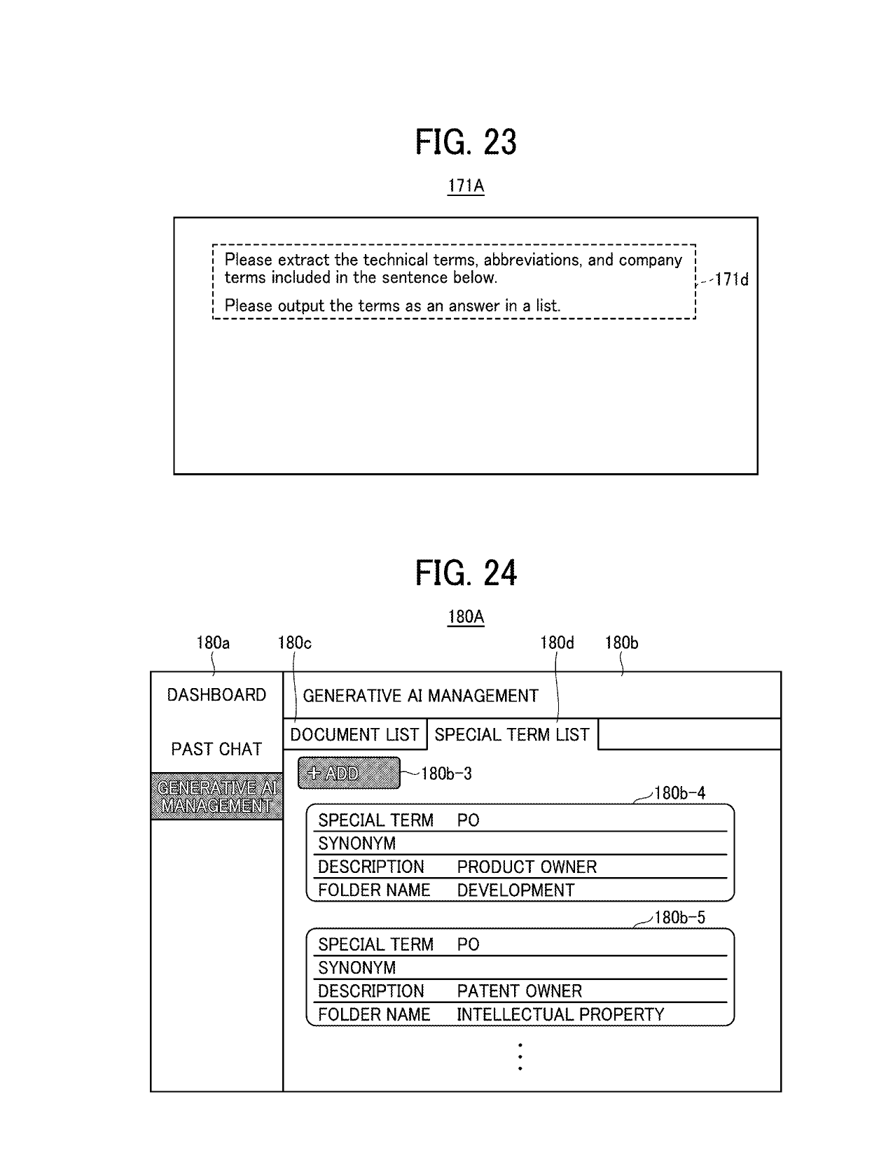

With reference to FIG. 23, the prompt generated in step S2210 of FIG. 22 is described below. FIG. 23 is a diagram illustrating another example of the prompt generated in the third embodiment.

A prompt 171A illustrated in FIG. 23 includes text data 171d. The text data 171a is text data for requesting extraction of special terms from the chunk included in the prompt 171.

In the present embodiment, as described above, a special term not stored in the term dictionary DB 450 can be extracted from a chunk as a new special term, using the information processing apparatus 200 and the server apparatus 500.

### Fourth Embodiment

The chat system according to a fourth embodiment is described below with reference to FIGS. 24 to 28. The fourth embodiment differs from the first embodiment in that the term information includes a category corresponding to the content of the description of the special term. In the following description of the fourth embodiment, differences from the first embodiment are described. The same reference numerals are given to the same or corresponding functions or configurations as those of the first embodiment, and redundant descriptions thereof are omitted or simplified appropriately.

In the present embodiment, in the term information stored in the term dictionary DB 450, a special term is associated with a category corresponding to the content of the description of the special term. In the present embodiment, the category corresponding to the content of the description of the special term may be information indicating the storage location of a file in the file DB 410.

In the present embodiment, the file DB 410 is provided with multiple storage areas, and a file is stored in each storage area according to the setting set by, for example, the administrator of the chat system 100. In the following description, each of the multiple storage areas in the file DB 410 is referred to as a folder.

In the present embodiment, the folder name of a folder in the file DB 410 is associated, as a category corresponding to the content of the description of a special term, with the special term. In other words, the term information of the present embodiment includes a special term and information indicating the storage location of a file having a content whose category matches the category of the description of the special term.

For example, the information indicating the storage location of the file may be input on the screen for adding term information. In this case, the screen for adding the term information includes an input field for inputting a folder name to be associated with the special term.

FIG. 24 is a first diagram illustrating a display example displayed on the display of the terminal apparatus 700 according to the fourth embodiment. A screen 180A illustrated in FIG. 24 is an example of a screen displayed on the display of the terminal apparatus 700, and is an example of a screen presenting a list of pieces of term information in each of which a special term and a folder name are associated with each other.

The display field 180b on the screen 180A includes an operation button 180b-3, a display field 180b-4, and a display field 180b-5. In the term information displayed in the display field 180b-4, it can be seen that a special term “PO,” a description “product owner,” and a folder name “development” are associated with one another. In the term information displayed in the display field 180b-5, it can be seen that a special term “PO,” a description “patent owner,” and a folder name “intellectual property” are associated with one another.

In the present embodiment, by associating the special term with the information indicating the storage location of the file having the content relating to the special term, the description of the special term corresponding to the content of the question can be appended to the question data even when a homonym of the special term exists.

In the present embodiment, for example, the folder name in the file DB 410 may be displayed on the display of the terminal apparatus 600 as a category corresponding to the content of the question.

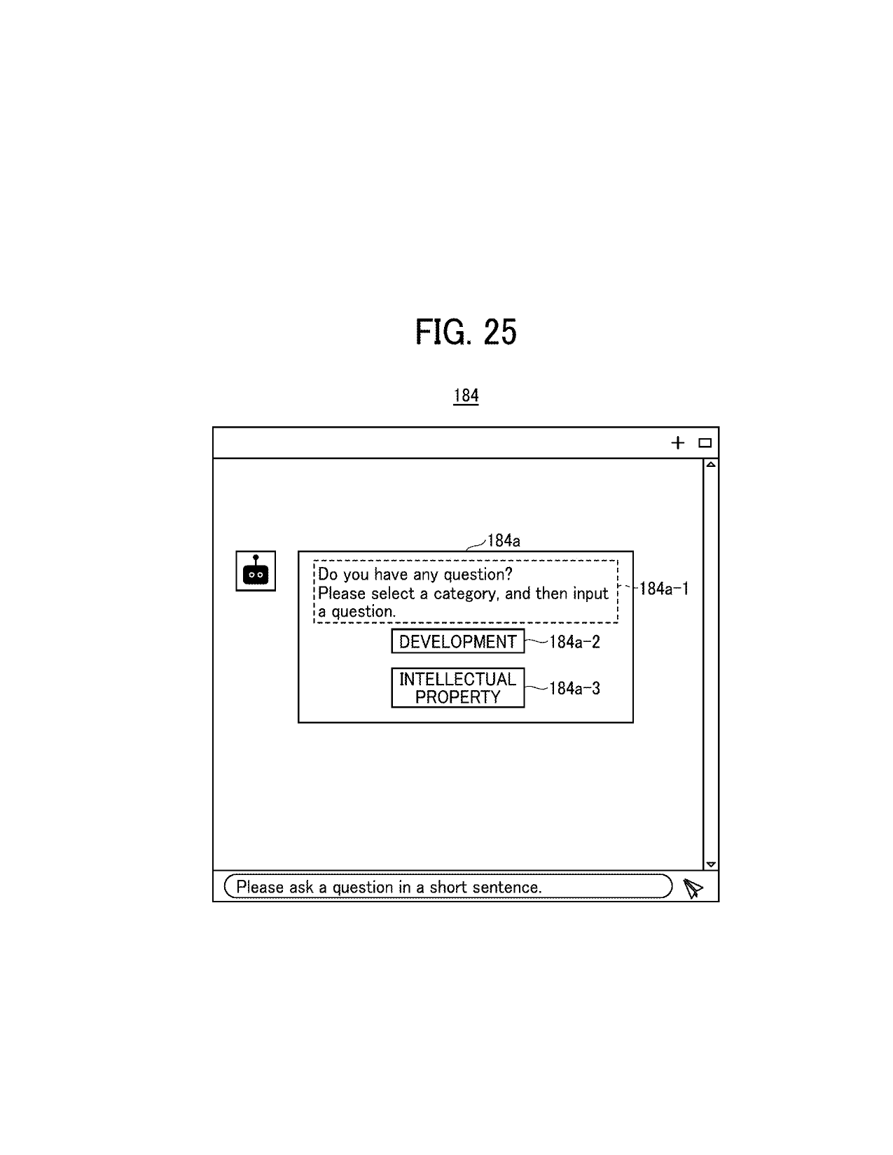

FIG. 25 is a second diagram illustrating a display example displayed on the display of the terminal apparatus 600 according to the fourth embodiment. A screen 184 illustrated in FIG. 25 is an example of an input screen when the user inputs question data on the terminal apparatus 600.

The screen 184 includes a display field 184a. The display field 184a includes text data 184a-1, an operation button 184a-2, and an operation button 184a-3. The text data 184a-1 is text data for prompting the user to select a category corresponding to the content of the question indicated by the question data to be input by the user.

The operation buttons 184a-2 and 184a-3 are each an operation button for selecting a category. In other words, the operation buttons 184a-2 and 184a-3 are each an operation button for selecting a folder generated in the file DB 410.

In the present embodiment, for example, when question data is input after the operation button 184a-2 is selected, “development,” which is the category of the question indicated by the question data, is transmitted to the information processing apparatus 200 with the question data.

In this case, for example, when transmitting an acquisition request for acquiring term information to the second storage device 400, the information processing apparatus 200 includes the “development” indicating the selected category in the acquisition request for acquiring term information and acquires term information including the “development” (see FIG. 10). In other words, the information processing apparatus 200 includes, as the category corresponding to the content of the question, the folder name in the file DB 410 in the search request for searching for the term information to the second storage device 400, and acquires the term information including the folder name included in the search request from the second storage device 400.

Accordingly, according to the present embodiment, even when a homonym of the special term stored in the term dictionary DB 450 exists, or when a special term that is similar in pronunciation but different in meaning exists, term information including a special term suitable for the content of the question can be obtained.

When the user inputs question data without selecting a category, the information processing apparatus 200 of the present embodiment transmits a prompt, to the server apparatus 500, requesting the server apparatus 500 to infer the category of the content of the question indicated by the question data based on the context of the question data input by the user.

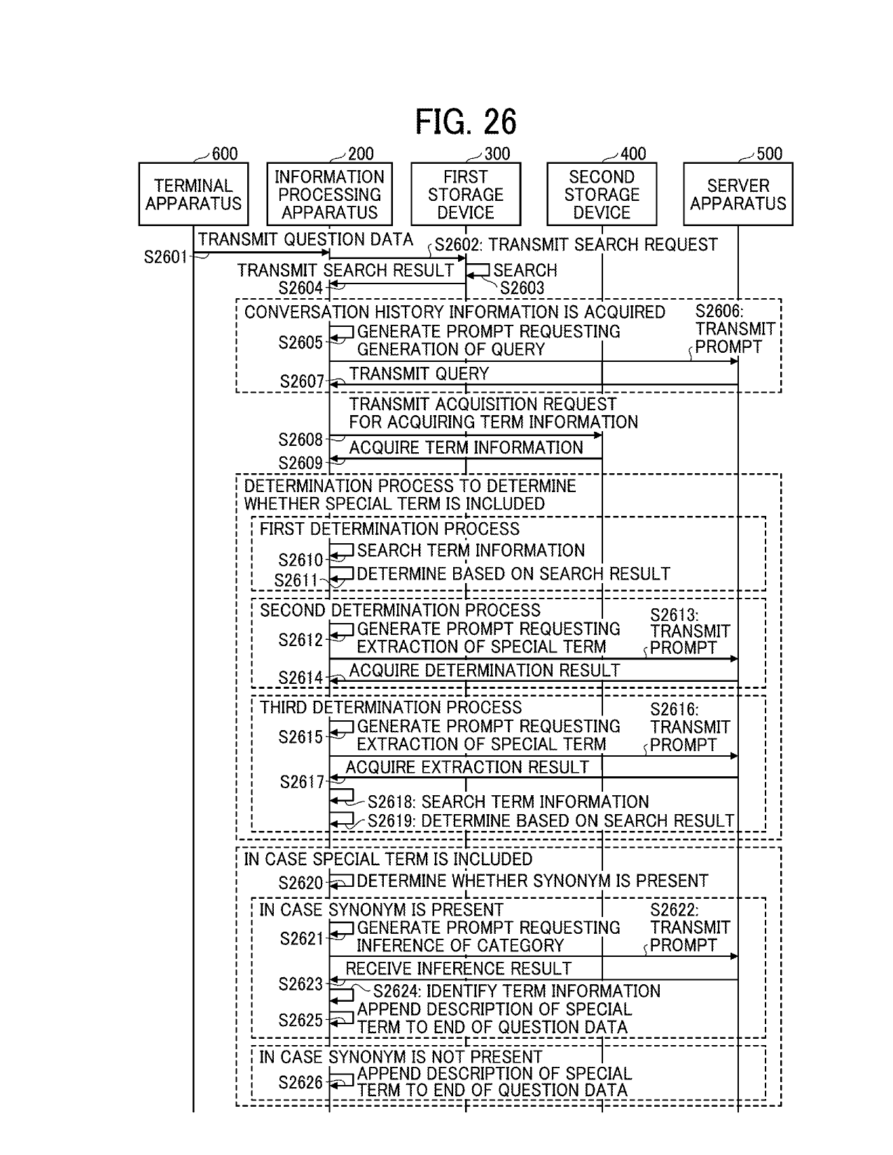

With reference to FIG. 26, the operation performed by the chat system 100 when the user inputs the question data without selecting a category is described below.

FIG. 26 is a sequence diagram illustrating the operation performed by the chat system 100 according to the fourth embodiment. The processes in steps S2601 to S2619 of FIG. 26 are substantially the same as those in steps S1001 to S1019 of FIG. 10, and the descriptions thereof are omitted.

In step S2620, when it is determined that a special term is included in the question data, the information processing apparatus 200 performs, with the determination unit 258, a determination process to determine whether a homonym of the special term included in the question data is present among the special terms included in the term information acquired in step S2609. At this point, the determination unit 258 may also determine whether a term that is similar in pronunciation but different in meaning from the special term included in the question data is present among the special terms included in the term information acquired in step S2609.

In step S2621, when it is determined that a homonym of the special term included in the question data or a term that is similar in pronunciation but different in meaning from the special term included in the question data is present among the special terms included in the term information, the information processing apparatus 200 generates, with the prompt generation unit 255, a prompt requesting inference of a category corresponding to the content of the question indicated by the question data. The prompt generated at this point will be described in detail later.

In step S2622, the information processing apparatus 200 transmits, with the prompt output unit 256, the prompt generated in step S2621 to the server apparatus 500. In step S2623, the information processing apparatus 200 receives, with the response acquisition unit 262, the information indicating the category indicating the content of the question, which is output from the server apparatus 500 as response data to the prompt.

In step S2624, the information processing apparatus 200 identifies, with the description appending unit 259, term information to be included in the question data. Specifically, the description appending unit 259 identifies, as the term information whose description is to be included in the question data, the term information that includes the special term included in the question data and includes a folder name associated with the category inferred in step S2623 among the homonyms of the special term or the terms that are similar in pronunciation but different in meaning included in the term information.

In step S2625, the description appending unit 259 appends the description included in the term information identified in step S2624 to the end of the question data.

In the determination process to determine whether a homonym of the special term included in the question data is present among the special terms included in the term information acquired in step S2609, in the case where it is determined that a homonym of the special term included in the question data or a term that is similar in pronunciation but different in meaning from the special term included in the question data is not present, the information processing apparatus 200 proceeds to step S2626.

The process in step S2626 of FIG. 26 is substantially the same as that in step S1020 of FIG. 10, and the descriptions thereof are omitted.

In the chat system 100 of the present embodiment, after the process in step S2626, the processes in steps S1021 to S1030 of FIG. 10 are performed.

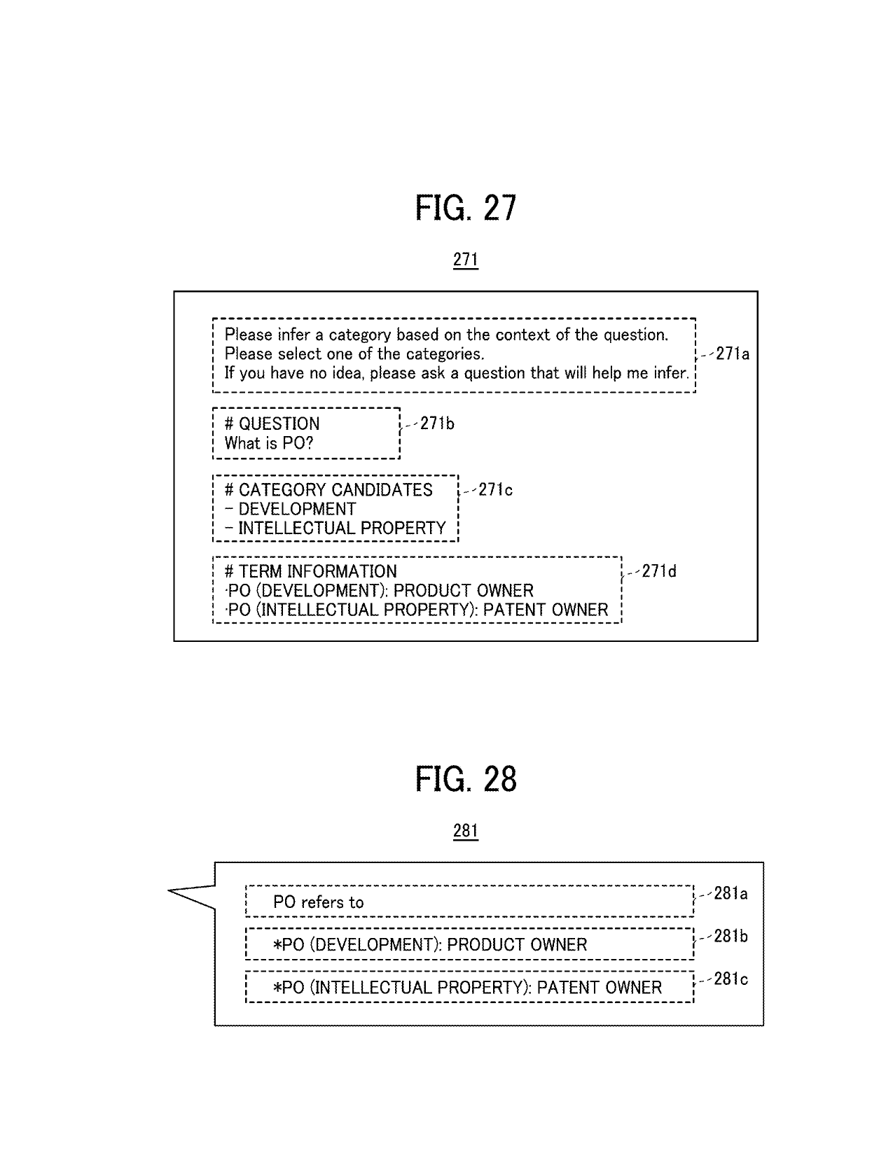

With reference to FIG. 27, the prompt generated in step S2616 of FIG. 26 is described below. FIG. 27 is a diagram illustrating an example of the prompt generated in the fourth embodiment.

A prompt 271 illustrated in FIG. 27 is an example of the prompt generated in step S2616 of FIG. 26.

The prompt 271 includes text data 271a, text data 271b, text data 271c, and text data 271d. The text data 271a includes text data for requesting inference of a category corresponding to the content of the question indicated by the question data. In addition, when the category cannot be inferred, the text data 271a includes text data for requesting generation of a question for inferring a category.

The text data 271b indicates the question data input in step S2601. The text data 271c indicates a category (folder name) associated with the special term included in the question data input in the term information. The text data 271d indicates term information including the special term included in the question data.

In the example of FIG. 27, it can be seen that the special term “PO” is included in the question data, two pieces of term information including the special term “PO” are stored in the term dictionary DB 450, and the categories (folder names) associated with the special term included in the two pieces of term information are the “development” and the “intellectual property,” respectively.

In the information processing apparatus 200 according to the present embodiment, when the information acquisition unit 254 acquires the term information from the second storage device 400, the term information whose category matches the content of the question indicated by the question data is acquired. Subsequently, the information processing apparatus 200 performs a determination process to determine whether a special term is included in the question data using the acquired term information. Accordingly, according to the present embodiment, the determination process can be performed based on the term information corresponding to the content of the question indicated by the question data. Thus, the accuracy of the answer to the question is increased.

In addition, the information processing apparatus 200 according to the present embodiment associates the special term with the category corresponding to the content of the description of the special term in the term information. Thus, even when a homonym of the special term is present in the term dictionary DB 450, the description of the special term suitable for the content of the question indicated by the question data can be appended to the question data. As a result, according to the present embodiment, the accuracy of the answer to the question is increased.

The information processing apparatus 200 in the present embodiment may be configured not to request inference of a category corresponding to the content of the question when the user inputs the question data without selecting a category.

In this case, in step S1020 illustrated in FIG. 10, the information processing apparatus 200 may append, with the description appending unit 259, all of the categories (folder names) associated with the special term included in the term information, which is extracted from the term dictionary DB 450, to the end of the question data.

With reference to FIG. 28, the question data with description in the present embodiment is described below. FIG. 28 is a diagram illustrating an example of the question data to which a description of the special term is appended, according to the fourth embodiment.

Text data 281 illustrated in FIG. 28 includes text data 281a, text data 281b, and text data 281c. The text data 281a is question data input from the terminal apparatus 600. The text data 281b and the text data 281c are each text data indicating the description of the special term included in the text data 281a.

In FIG. 28, the special term included in the text data 281a is “PO,” the folder name associated with the special term “PO” in the text data 281b is the “development,” and the folder name associated with the special term “PO” in the text data 281c is the “intellectual property.”

In the present embodiment, even when multiple pieces of term information including the special term “PO” are stored in the term dictionary DB 450 and the meaning of the special term “PO” differs in each piece of term information, a chunk having a folder name matching each category of the special term can be acquired as a search result.

Accordingly, according to the present embodiment, each chunk can be included, as an information source, in a prompt requesting the server apparatus 500 to generate answer data to the question data. Thus, the accuracy of the answer to the question is increased.

### Fifth Embodiment

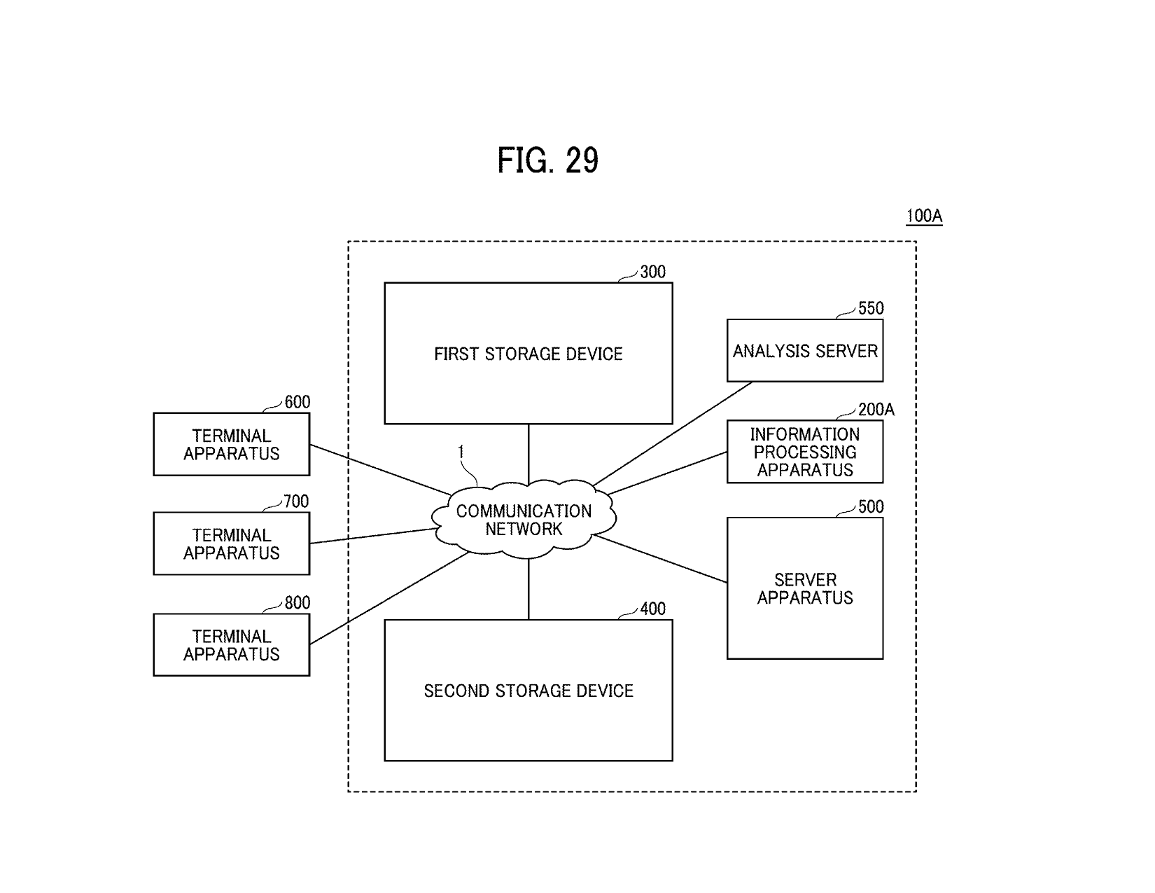

The chat system according to a fifth embodiment is described below with reference to FIGS. 29 to 35. The fifth embodiment is different from the first embodiment in that an information processing apparatus 200A performs processes by referring to process procedure information that defines the content of each process and the execution order of each process. In the following description of the fifth embodiment, differences from the first embodiment are described. The same reference numerals are given to the same or corresponding functions or configurations as those of the first embodiment, and redundant descriptions thereof are omitted or simplified appropriately.

FIG. 29 is a diagram illustrating a system configuration of a chat system 100A according to the fifth embodiment. The chat system 100A, which is an example of an information processing system, includes the information processing apparatus 200A, the first storage device 300, the second storage device 400, the server apparatus 500, and the analysis server 550, which are connected to each other via the communication network 1. The chat system 100A is connected to the terminal apparatus 600, the terminal apparatus 700, and a terminal apparatus 800 via the communication network 1.

The information processing apparatus 200A in the present embodiment stores the process procedure information that defines the content of each process and the execution order of each process, and performs each process according to the content defined by the process procedure information in the defined execution order by referring to the process procedure information. In other words, the process procedure information of the present embodiment is an example of a workflow in which a series of flows for performing tasks and operations are defined and proceduralized. In the following description, the process procedure information is referred to as a workflow.

The terminal apparatus 800 in the present embodiment is a terminal apparatus primarily used for creating and editing a workflow, and is used by a user who manages process procedure information. Any of the terminal apparatuses 600 and 700 may also serve as the terminal apparatus 800.

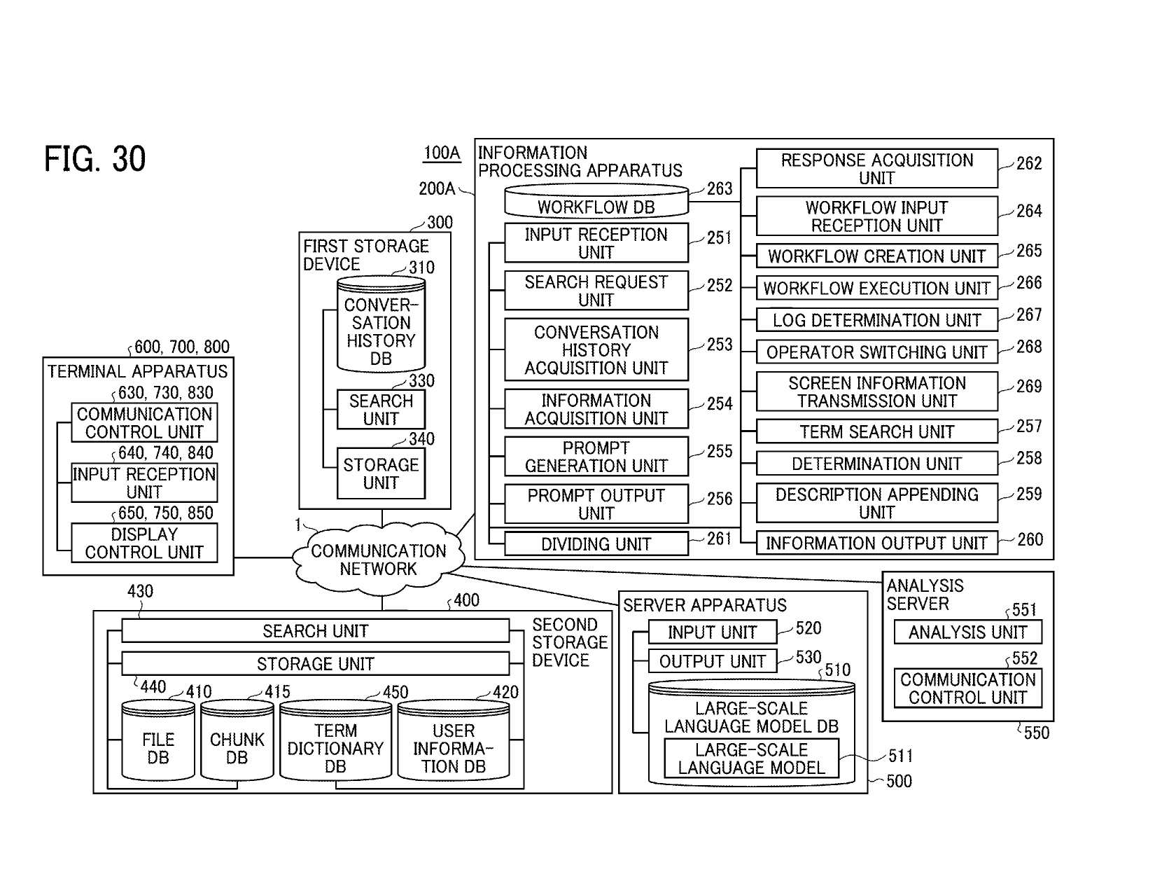

With reference to FIG. 30, the functions of the apparatuses or devices included in the chat system 100A are described below. FIG. 30 is a block diagram illustrating a functional configuration of each of the apparatuses or devices included in the chat system 100A according to the fifth embodiment.

The information processing apparatus 200A according to the present embodiment includes, in addition to the functional units of the information processing apparatus 200, a workflow DB 263, a workflow input reception unit 264, a workflow creation unit 265, a workflow execution unit 266, a log determination unit 267, an operator switching unit 268, and a screen information transmission unit 269.

The workflow DB 263 stores workflows. The workflow DB 263 will be described in detail later.

When an operation for creating or editing a workflow is performed on a workflow creation screen or a workflow editing screen displayed on the display of the terminal apparatus 800, the workflow input reception unit 264 receives an input corresponding to the operation performed on the display of the terminal apparatus 800. The workflow creation unit 265 creates a workflow in accordance with the content received by the workflow input reception unit 264, and stores the workflow in the workflow DB 263. The workflow execution unit 266 refers to an identified workflow among the workflows stored in the workflow DB 263, and performs each process of the content defined in the workflow in the defined execution order.

The log determination unit 267 refers to the conversation history information stored in the conversation history DB 310, and audits the content of answer data output in response to question data. The conversation history information in the present embodiment may include information indicating evaluation by the user for the answer data. The log determination unit 267 determines whether the answer data is appropriate, for example, based on the evaluation by the user for each piece of answer data to the question data.

The operator switching unit 268 switches the transmission destination of the question data from the server apparatus 500 to, for example, an operator at the inquiry desk in accordance with the result of the determination performed by the log determination unit 267. For example, when the number of times the log determination unit 267 determines that the answer data is not appropriate is equal to or greater than a predetermined number of times, the operator switching unit 268 can switch the transmission destination of the question data from the server apparatus 500 to the operator.

The screen information transmission unit 269 transmits screen information for causing the terminal apparatus 800 to display the workflow creation screen or the workflow editing screen to the terminal apparatus 800.

In the example of FIG. 30, the information processing apparatus 200A includes the workflow DB 263. However, the configuration is not limited thereto. For example, the workflow DB 263 may be included in an external apparatus that communicates with the information processing apparatus 200A. Further, in the example of FIG. 30, the information processing apparatus 200A includes the workflow input reception unit 264, the workflow creation unit 265, the workflow execution unit 266, the log determination unit 267, the operator switching unit 268, and the screen information transmission unit 269. However, the configuration is not limited thereto. Some or all of these functional units, together with the workflow DB 263, may be included in an external apparatus that communicates with the information processing apparatus 200A.

The functional configuration of the terminal apparatus 800 is described below. The terminal apparatus 800 includes a communication control unit 830, an input reception unit 840, and a display control unit 850. In the terminal apparatus 800, the communication control unit 830, the input reception unit 840, and the display control unit 850 may be each implemented by a web browser included in the terminal apparatus 800, or may be each implemented by means different from the web browser.

The communication control unit 830 controls communication between the terminal apparatus 800 and the information processing apparatus 200A. The input reception unit 840 receives input to the terminal apparatus 800. The display control unit 850 controls display on the display of the terminal apparatus 800.

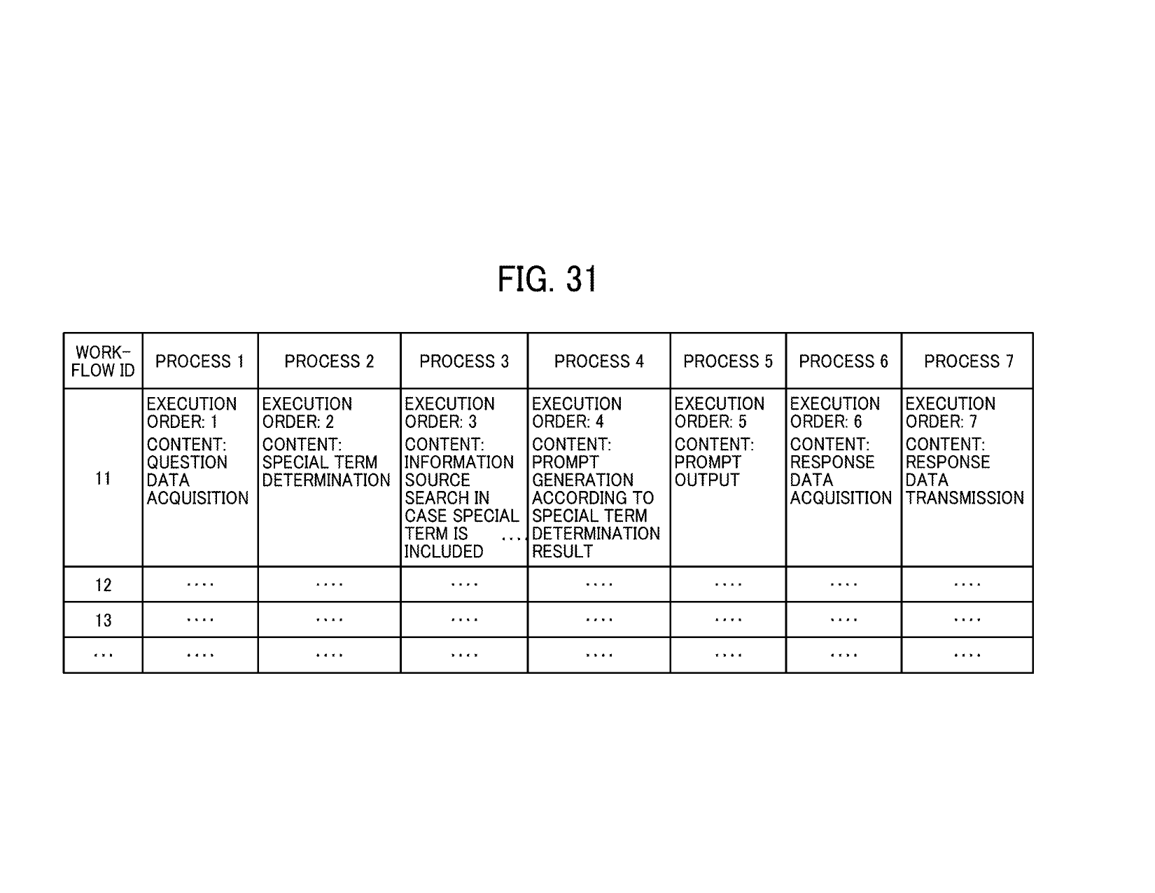

With reference to FIG. 31, the workflow DB 263 of the present embodiment is described below. FIG. 31 is a diagram illustrating an example of the workflow DB 263.

A workflow (process procedure information) stored in the workflow DB 263 of the present embodiment includes, as information items, a workflow ID, a process 1, a process 2, a process 3, a process 4, a process 5, a process 6, a process 7. The item “workflow ID” is associated with the rest of the items. In the example of FIG. 31, the processes associated with the workflow ID are defined as processes 1 to 7. However, the number of processes may be changed as desired according to the operation defined by the workflow. Workflows can be created and edited by the user.

The item “workflow ID” has a value, which is an identifier for identifying a workflow. The items “process 1” to “process 6” each have a value, which indicates the content of each process and the execution order of each process.

In the example of FIG. 31, the workflow identified with a workflow ID “11” defines a process to receive question data, a process to determine whether a special term is included in the question data, a process to search for an information source when the special term is included, a process to generate a prompt according to a determination result of whether the special term is included, a process to output the prompt, a process to acquire response data from the large-scale language model 511, and a process to transmit the response data.

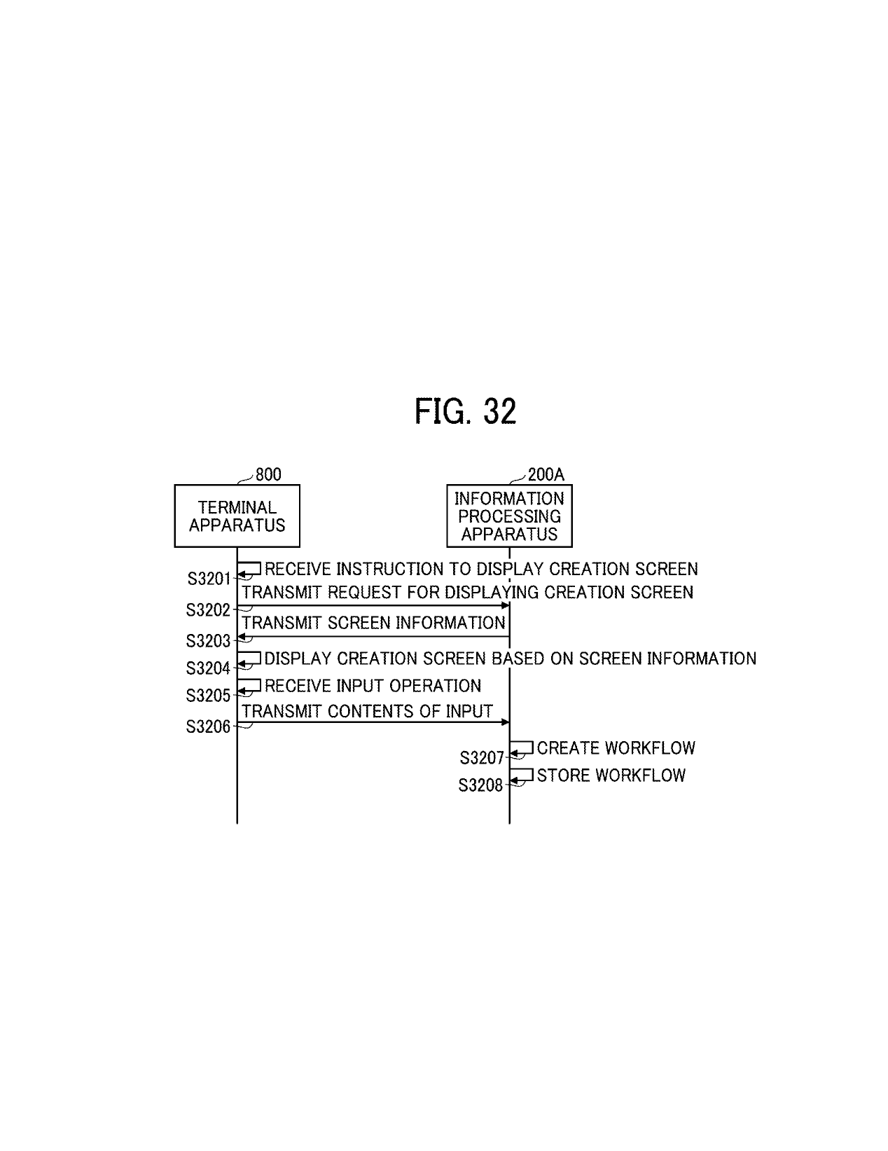

With reference to FIG. 32, the operation performed by the information processing apparatus 200A of the present embodiment when a workflow is created is described below. FIG. 32 is a first sequence diagram illustrating the operation performed by the chat system 100A according to the fifth embodiment.

In step S3201, in the chat system 100A of the present embodiment, the terminal apparatus 800 receives, with the input reception unit 840, an operation for instructing display of the workflow creation screen. In step S3202, the terminal apparatus 800 transmits, with the communication control unit 830, a request for displaying the workflow creation screen to the information processing apparatus 200A.

In step S3203, when receiving, with the input reception unit 251, the request of the display, the information processing apparatus 200A transmits, with the screen information transmission unit 269, screen information for displaying the workflow creation screen to the terminal apparatus 800.

In step S3204, in response to receiving the screen information, the terminal apparatus 800 causes, with the display control unit 850, the workflow creation screen to be displayed based on the screen information. In step S3205, the terminal apparatus 800 receives, with the input reception unit 840, an operation of input on the workflow creation screen. In step S3206, the terminal apparatus 800 transmits, with the communication control unit 830, the input content to the information processing apparatus 200A.

When receiving the input content on the workflow creation screen with the workflow input reception unit 264, the information processing apparatus 200A creates, with the workflow creation unit 265, a workflow in accordance with the input content in step S3207, and stores the created workflow in the workflow DB 263 in step S3208.

In the example of FIG. 32, the workflow creation unit 265 of the information processing apparatus 200A creates the workflow. In another embodiment, another functional unit may create the workflow.

In the present embodiment, by including programs for implementing the workflow input reception unit 264 and the workflow creation unit 265 in the screen information to be transmitted from the information processing apparatus 200A to the terminal apparatus 800, the terminal apparatus 800 can be provided with the functions of the workflow input reception unit 264 and the workflow creation unit 265.

In other words, the screen information to be transmitted from the information processing apparatus 200A to the terminal apparatus 800 can include a program for creating a workflow in accordance with the operation on the workflow creation screen displayed on the terminal apparatus 800. The program included in the screen information is, for example, a program described in JavaScript^{®}. In response to receiving the screen information, the terminal apparatus 800 executes the program included in the screen information using the web browser. In the present embodiment, by executing the program included in the screen information on the terminal apparatus 800, a workflow is created in accordance with the operation on the workflow creation screen displayed on the terminal apparatus 800.

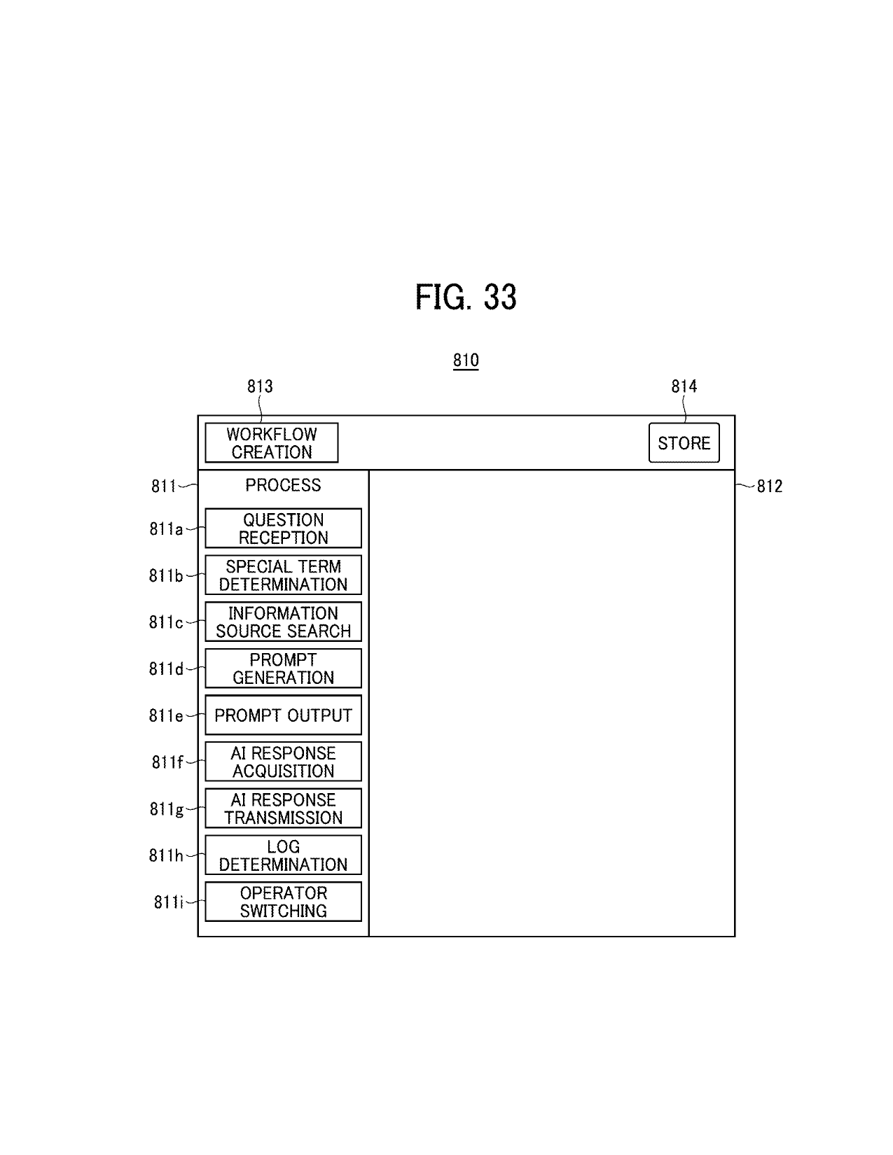

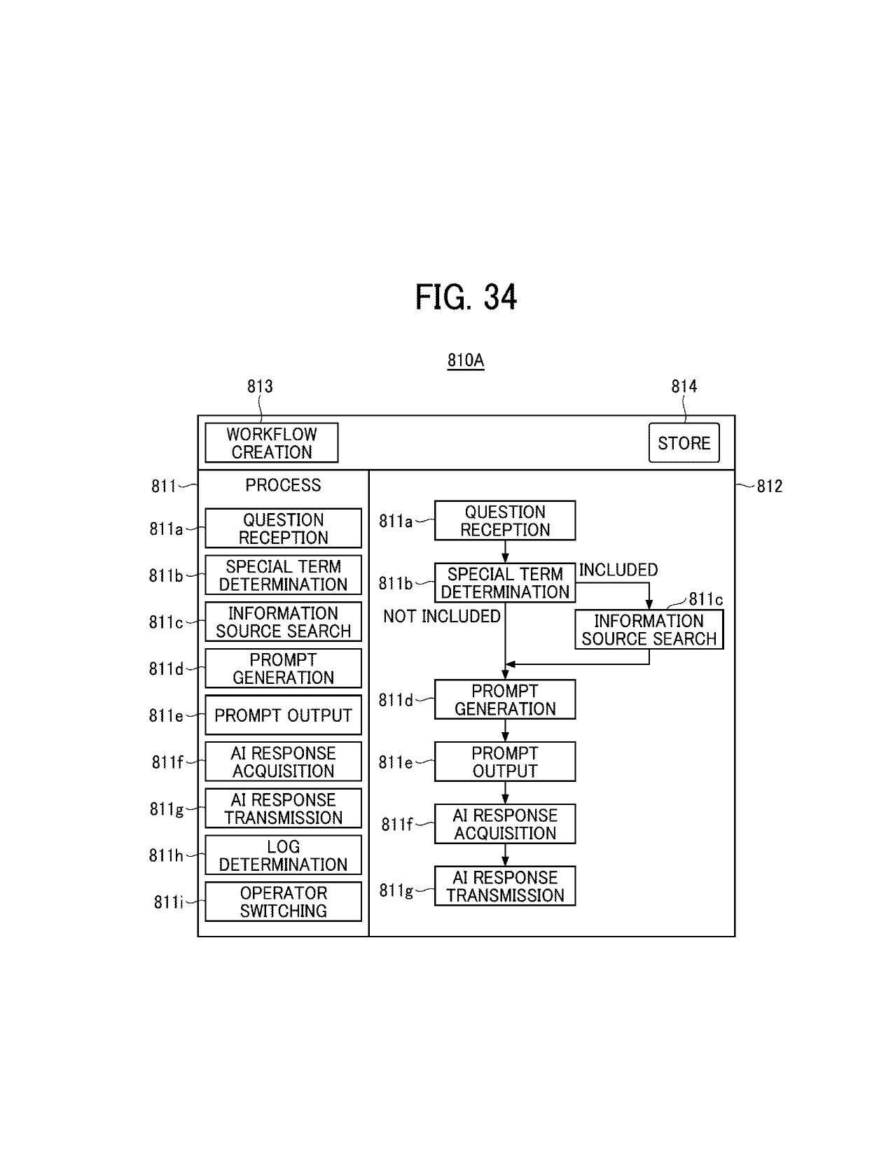

With reference to FIGS. 33 and 34, display examples displayed on the display of the terminal apparatus 800 are described below. FIG. 33 is a first diagram illustrating a display example displayed on the display of the terminal apparatus 800 according to the fifth embodiment.

A screen 810 illustrated in FIG. 33 is an example of the workflow creation screen displayed on the display of the terminal apparatus 800 in step S3201 of FIG. 32. The screen 810 includes a display field 811, a display field 812, an operation button 813, and an operation button 814. The display field 811 is an example of a first display field. The display field 812 is an example of a second display field.

In the display field 811, a list of processes that can be included in the workflow is displayed as a list of operation components corresponding to the processes. In the display field 812, operation components selected from the list of operation components displayed in the display field 811 are arranged.

The operation button 813 is an operation button for instructing creation of a workflow. In the present embodiment, for example, when the operation button 813 is operated after the operation components are arranged in the display field 812, a workflow is created in accordance with the arrangement of the operation components in the display field 812.

The operation button 814 is an operation button for storing the created workflow in the workflow DB 263. In the present embodiment, for example, after the operation button 813 is operated and the workflow is created, a message may be displayed to the user of the terminal apparatus 800 for confirming whether to store the workflow in the workflow DB 263. In the present embodiment, for example, when the operation button 814 is operated after this message is displayed, the workflow is stored in the workflow DB 263.

In the display field 811, operation components 811a to 811i are displayed as a list of operation components corresponding to the processes. The processes displayed as the operation components in the display field 811 are processes that can be performed in the information processing apparatus 200A.

In the example of FIG. 33, the operation component 811a indicates a process to receive question data. The operation component 811b indicates a first determination process to determine whether a special term is included in the question data. The operation component 811c indicates a process to search the second storage device 400 for an information source when the special term is included. The operation component 811d indicates a process to generate a prompt to be transmitted to the server apparatus 500. The operation component 811e indicates a process to output the prompt to the server apparatus 500. The operation component 811f indicates a process to acquire response data output from the server apparatus 500. The operation component 811g indicates a process to transmit the response data acquired from the server apparatus 500 to the outside. The operation component 811h indicates a process to determine whether appropriate answer data has been output in response to the question data based on the conversation history information stored in the first storage device 300. The operation component 811i indicates a process to switch the transmission destination of the question data from the server apparatus 500 to the operator.

FIG. 34 is a second diagram illustrating a display example displayed on the display of the terminal apparatus 800 according to the fifth embodiment. A screen 810A illustrated in FIG. 34 is an example of the screen as displayed after the operation of input for creating a workflow is performed in step S3205 of FIG. 32.

On the screen 810A, the operation components 811a, 811b, 811c, 811d, 811e, 811f, and 811g are arranged in the display field 812. The operation components 811a to 811g define the process to receive question data, the process to determine whether a special term is included in the question data, the process to search for an information source when the special term is included, the process to generate a prompt, the process to output the prompt, the process to acquire response data from the large-scale language model 511, and the process to transmit the response data, respectively.

In the present embodiment, when the operation button 813 is selected on the screen 810A, a workflow is created that defines the contents of the processes indicated by the operation components arranged in the display field 812 and the order in which the operation components are arranged. In addition, when the operation button 814 is further selected after the operation button 813 is selected on the screen 810A, a workflow ID is assigned to the created workflow and the workflow is stored in the workflow DB 263.

In the present embodiment, simply by selecting and arranging the operation components indicating a list of processes as described above, a workflow that defines the contents and execution order of the processes to be executed in the chat system 100A can be created. Accordingly, according to the present embodiment, even a user who does not have technical knowledge for creating a workflow can easily create a workflow.

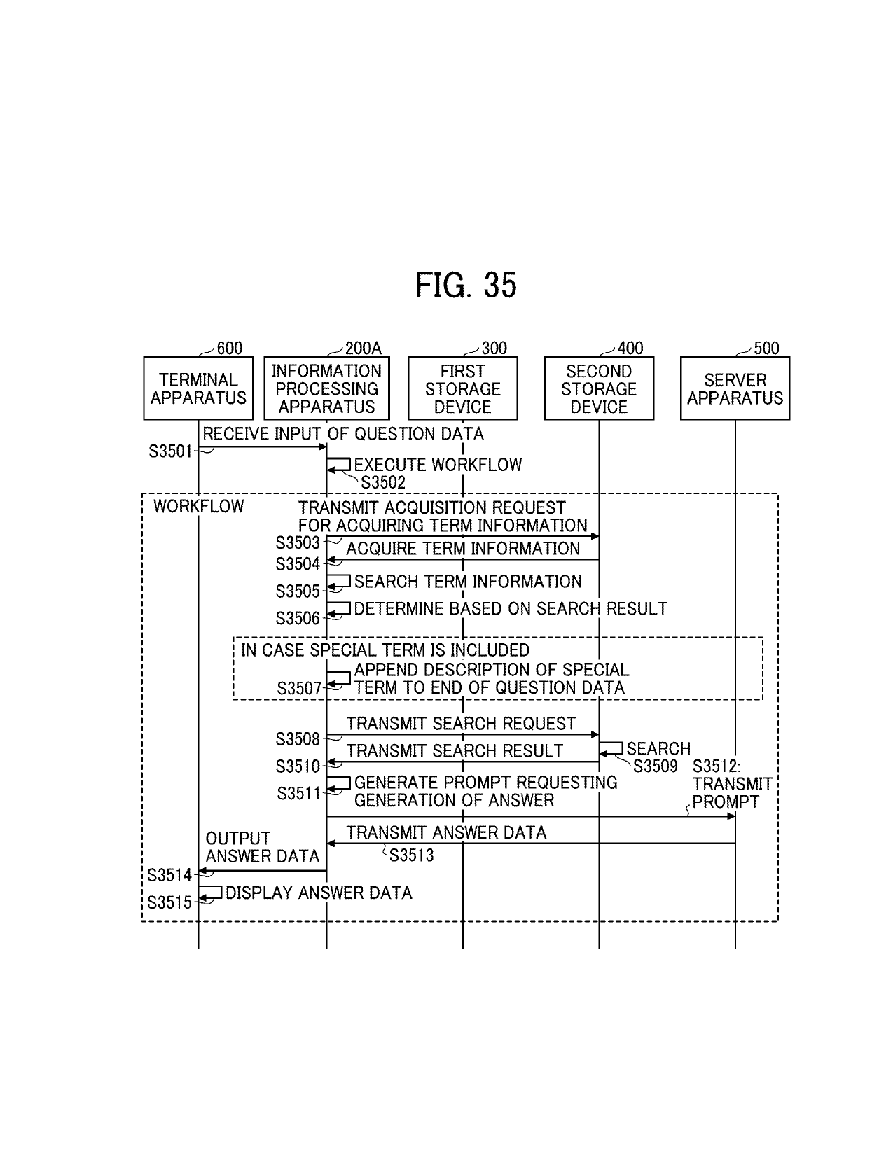

With reference to FIG. 35, the operation performed when a workflow stored in the workflow DB 263 is performed in the chat system 100A according to the present embodiment is described below. FIG. 35 is a second sequence diagram illustrating the operation performed by the chat system 100A according to the fifth embodiment.

In the chat system 100A, when receiving an input of question data from the terminal apparatus 600 in step S3501, the information processing apparatus 200A, with the workflow execution unit 266, refers to the workflow to be executed when the question data is received and performs the processes based on the workflow in step S3502.

In the present embodiment, for example, it is assumed that the information processing apparatus 200A is set in advance to refer to the workflow identified with the workflow ID “11” when question data is input. This setting can be set by the administrator of the chat system 100A or can be set by the user of the terminal apparatus 800 when creating a workflow.

The processes in step S3503 and subsequent steps of FIG. 35 indicate processes in the case where the workflow execution unit 266 of the information processing apparatus 200A executes the functions of the information processing apparatus 200A in accordance with the workflow.

The processes in steps S3503 and S3504 of FIG. 35 are substantially the same as those in steps S1008 and S1009 of FIG. 10, the processes in steps S3505 and S3506 of FIG. 35 are substantially the same as those in steps S1010 and S1011 of FIG. 10, and the descriptions thereof are omitted.

Also, the processes in steps S3507 to S3515 of FIG. 35 are substantially the same as those in steps S1020 to S1028 of FIG. 10, and the descriptions thereof are omitted.

In FIG. 35, as an example of the operation performed when the workflow is executed, the execution of some of the processes performed by the information processing apparatus 200 illustrated in FIG. 10 has been described. In the present embodiment, if a workflow is created that defines all the processes performed by the information processing apparatus 200 in the sequence diagram illustrated in FIG. 10 and the execution order illustrated in FIG. 10, the processes to be performed by the information processing apparatus 200 illustrated in FIG. 10 can be performed by executing the workflow.

In the present embodiment, by creating a workflow including a determination process to determine whether a special term is included as described above, an answer in consideration of the special term included in the question can be output.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses or devices described in the above-described embodiments is merely one example of multiple computing environments for implementing the embodiments disclosed herein.

In some embodiments, the information processing apparatus 200 includes multiple computing devices, such as a server cluster. The multiple computing devices communicate with each other through any type of communication links, including a network or a shared memory to perform the processes disclosed herein. Similarly, the information processing apparatus 200 may include multiple computing devices that communicate with each other.

Further, the information processing apparatus 200 may share the processing steps disclosed herein in various combinations. For example, the processes performed by one or more predetermined units may be performed by any one of the computing devices operating as the information processing apparatus 200. Similarly, the functions performed by one or more predetermined units may be performed by any one of the computing devices operating as the information processing apparatus 200. Further, the elements of the information processing apparatus 200 may be combined into a single server apparatus, or divided between multiple apparatuses in combinations other than those described above.

The information processing apparatus 200 is not limited to an image forming apparatus, and may be any apparatus having a communication function implemented by communication circuity. The information processing apparatus 200 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, or a desktop PC.

Aspects of the present disclosure are, for example, as follows.

According to Aspect 1, an information processing apparatus that, when receiving an input of question data from a user via a terminal apparatus, outputs answer data to the question data, includes an input reception unit that receives the input of the question data, a determination unit that refers to a term dictionary database that stores term information in which each of a plurality of terms is associated with information indicating the meaning of a term to perform a determination process to determine whether the term is included in the input question data, an acquisition unit that, when it is determined that the term is included in the question data, acquires the information indicating the meaning of the term from the term dictionary database, a search request unit that transmits a search request including the information indicating the meaning of the term included in the question data and the question data to a file database storing a file that serves as an information source of the answer data to the question data, a prompt generation unit that generates a prompt requesting generation of the answer data to the question data based on the file identified by searching the file database according to the search request including the information indicating the meaning of the term included in the question data, a prompt output unit that outputs the prompt generated by the prompt generation unit to a large-scale language model, and an information output unit that outputs, to the terminal apparatus, the answer data output by the large-scale language model based on the prompt output from the prompt output unit.

According to Aspect 2, in the information processing apparatus of Aspect 1, the input reception unit receives a registration request for registering the file to be stored in the file database from another terminal apparatus different from the terminal apparatus, the prompt generation unit generates a prompt requesting extraction of the term included in the file for which the registration request is received, the prompt output unit outputs, to the large-scale language model, the prompt generated by the prompt generation unit requesting the extraction of the term included in the file for which the registration request is received, and the information output unit refers to the term dictionary database to cause the file database to store the information indicating the meaning of the term extracted by the large-scale language model and the file in association with each other.

According to Aspect 3, in the information processing apparatus of Aspect 1 or 2, the determination process performed by the determination unit includes a first determination process, a second determination process, and a third determination process. The first determination process is a process to search the question data using the term included in the term information as a search key and determine whether the term is included in the question data according to the search result. The second determination process is a process to output, with the prompt output unit, to the large-scale language model, the prompt that is generated by the prompt generation unit, requests the extraction of the term from the question data, and includes the term information stored in the term dictionary database, and determine whether the term is included in the question data according to a response output from the large-scale language model. The third determination process is a process to output, with the prompt output unit, to the large-scale language model, the prompt that is generated by the prompt generation unit and requests the extraction of the term from the question data, acquire the extraction result provided by the large-scale language model, and determine whether the term is included in the question data according to a determination of whether the term information stored in the term dictionary database includes the term that matches the term included in the extraction result.

According to Aspect 4, in the information processing apparatus of any one of Aspects 1 to 3, the input reception unit receives, from the other terminal apparatus different from the terminal apparatus, a request for generating the term information based on the file selected from among the files stored in the file database, the prompt generation unit generates a prompt requesting extraction of the term from the selected file, the prompt output unit outputs, to the large-scale language model, the prompt requesting the extraction of the term from the selected file, and the information output unit outputs, to the other terminal apparatus, the term output by the large-scale language model as a candidate of the term to be included in the term information.

According to Aspect 5, in the information processing apparatus of any one of Aspects 1 to 4, the term information includes the term, the information indicating the meaning of the term, and a category corresponding to the meaning of the term, the input reception unit receives an input of the category corresponding to the content of a question indicated by the question data, and the search request unit transmits, to the file database, the search request including the information indicating the meaning of the term that is included in the term information stored in the term dictionary database and has the category matching the category corresponding to the content of the question indicated by the question data.

According to Aspect 6, in the information processing apparatus of any one of Aspects 1 to 5, the term information includes the term, the information indicating the meaning of the term, and the category corresponding to the meaning of the term, the prompt generation unit generates a prompt requesting inference of the category corresponding to the content of the question indicated by the question data, the prompt output unit transmits the prompt requesting the inference of the category corresponding to the content of the question indicated by the question data to the large-scale language model, and the search request unit transmits, to the file database, the search request including the information indicating the meaning of the term that is included in the term information stored in the term dictionary database and has the category matching the category corresponding to the content of the question inferred by the large-scale language model.

According to Aspect 7, in the information processing apparatus of any one of Aspects 1 to 6, the term information includes the term, the information indicating the meaning of the term, and the category corresponding to the meaning of the term, and the search request unit refers to the term information stored in the term dictionary database to transmit the search request including the information indicating the meaning of the term included in the question data and the category corresponding to the meaning of the term to the file database.

According to Aspect 8, in the information processing apparatus of any one of Aspects 1 to 7, the information indicating the meaning of the term is text data indicating the description of the term or a synonym having a meaning similar to the term.

According to Aspect 9, an information processing apparatus that, when receiving an input of question data from a user via a terminal apparatus, outputs answer data to the question data, includes an input reception unit that receives, from another terminal apparatus different from the terminal apparatus, a registration request for registering a file in a file database in which the file that serves as an information source of the answer data to the question data is stored, a prompt generating unit that generates a prompt requesting extraction of a term included in a term dictionary database storing term information in which the term is associated with information indicating the meaning of the term, from the file for which the registration request is received, a prompt output unit that outputs the prompt generated by the prompt generation unit to a large-scale language model, and an information output unit that refers to the term dictionary database to cause the file database to store the information indicating the meaning of the term extracted by the large-scale language model based on the prompt output by the prompt output unit and the file in association with each other.

According to Aspect 10, an information processing apparatus includes a screen information transmission unit that transmits, to a terminal apparatus, screen information for displaying a workflow creation screen for creating a workflow that defines the contents of processes according to an input from a user via a terminal apparatus, a creation unit that creates, according to the input to the workflow creation screen displayed on the terminal apparatus, the workflow that defines the contents of the processes, and an execution unit that executes the created workflow. The workflow created by the creation unit includes a process to receive an input of question data, a process to refer to a term dictionary database that stores term information in which a term is associated with information indicating the meaning of the term to perform a determination process to determine whether the term is included in the input question data, a process to acquire, when it is determined that the term is included in the question data, the information indicating the meaning of the term, a process to transmit a search request including the information indicating the meaning of the term included in the question data and the question data to a file database storing a file that serves as an information source of answer data to the question data, a process to generate a prompt requesting generation of the answer data to the question data based on the file identified by searching the file database according to the search request including the information indicating the meaning of the term, a process to output the generated prompt to a large-scale language model, a process to acquire response data output by the large-scale language model based on the output prompt, and a process to output the response data as the answer data to the question data.

According to Aspect 11, in the information processing apparatus according to Aspect 10, the workflow creation screen includes a first display field in which a list of operation components corresponding to the processes that the information processing apparatus can execute is displayed and a second display field in which the operation components are arranged. The creation unit creates the workflow based on the contents of the processes indicated by the operation components arranged in the second display field and the order in which the operation components are arranged.

According to Aspect 12, an information processing system includes a terminal apparatus and an information processing apparatus that, when receiving an input of question data from a user via the terminal apparatus, outputs answer data to the question data. The information processing apparatus includes an input reception unit that receives the input of the question data, a determination unit that refers to a term dictionary database that stores term information in which each of a plurality of terms is associated with information indicating the meaning of a term to perform a determination process to determine whether a term is included in the input question data, an acquisition unit that, when it is determined that the term is included in the question data, acquires the information indicating the meaning of the term from the term dictionary database, a search request unit that transmits a search request including the information indicating the meaning of the term included in the question data and the question data to a file database storing a file that serves as an information source of the answer data to the question data, a prompt generation unit that generates a prompt requesting generation of the answer data to the question data based on the file identified by searching the file database according to the search request including the information indicating the meaning of the term included in the question data, a prompt output unit that outputs the prompt generated by the prompt generation unit to a large-scale language model, and an information output unit that outputs the answer data output by the large-scale language model based on the prompt output from the prompt output unit to the terminal apparatus.

According to Aspect 13, an information processing method performed by an information processing apparatus includes receiving an input of question data, outputting, in response to receiving the input of the question data, answer data to the question data, referring to a term dictionary database that stores term information in which a term is associated with information indicating the meaning of the term to perform a determination process to determine whether the term is included in the input question data, acquiring, when it is determined that the term is included in the question data, the information indicating the meaning of the term from the term dictionary database, transmitting a search request including the information indicating the meaning of the term included in the question data and the question data to a file database storing a file that serves as an information source of the answer data to the question data, generating a prompt requesting generation of the answer data to the question data based on the file identified by searching the database according to the search request including the information indicating the meaning of the term included in the question data, outputting the generated prompt to a large-scale language model, and outputting the answer data output by the large-scale language model based on the output prompt to the terminal apparatus.

According to Aspect 14, a non-transitory recording medium stores a plurality of program codes which, when executed by one or more processors on an information processing apparatus, causes the one or more processors to perform a method including receiving an input of question data, outputting, in response to receiving the input of the question data, answer data to the question data, referring to a term dictionary database that stores term information in which a term is associated with information indicating the meaning of the term to perform a determination process to determine whether the term is included in the input question data, acquiring, when it is determined that the term is included in the question data, the information indicating the meaning of the term from the term dictionary database, transmitting a search request including the information indicating the meaning of the term included in the question data and the question data to a file database storing a file that serves as an information source of the answer data to the question data, generating a prompt requesting generation of the answer data to the question data based on the file identified by searching the file database according to the search request including the information indicating the meaning of the term included in the question data, outputting the generated prompt to a large-scale language model, and outputting the answer data output by the large-scale language model based on the output prompt to the terminal apparatus.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

In another aspect, an information processing system includes a terminal apparatus and an information processing apparatus. The information processing apparatus includes circuitry to receive an input of question data from a user via the terminal apparatus, output, in response to receiving the input of the question data, answer data to the question data, refer to a term dictionary database to perform a determination process, the term dictionary database storing term information in which a term is associated with information indicating a meaning of the term, the determination process being to determine whether the term is included in the question data, acquire, in a case that it is determined that the term is included in the question data, the information indicating the meaning of the term from the term dictionary database, transmit a search request to a file database, the search request including the information indicating the meaning of the term included in the question data and the question data, the file database storing a file serving as an information source of the answer data to the question data, generate a prompt requesting generation of the answer data to the question data based on the file identified by searching the file database according to the search request, output the prompt to a large-scale language model, and output the answer data output by the large-scale language model based on the prompt to the terminal apparatus.

In another aspect, a non-transitory recording medium stores a plurality of program codes which, when executed by one or more processors on an information processing apparatus, causes the one or more processors to perform a method including receiving an input of question data, outputting, in response to receiving the input of the question data, answer data to the question data, referring to a term dictionary database to perform a determination process, the term dictionary database storing term information in which a term is associated with information indicating a meaning of the term, the determination process being to determine whether the term is included in the question data, acquiring, in a case that it is determined that the term is included in the question data, the information indicating the meaning of the term from the term dictionary database, transmitting a search request to a file database, the search request including the information indicating the meaning of the term included in the question data and the question data, the file database storing a file serving as an information source of the answer data to the question data, generating a prompt requesting generation of the answer data to the question data based on the file identified by searching the file database according to the search request, outputting the prompt to a large-scale language model, and outputting the answer data output by the large-scale language model based on the prompt to a terminal apparatus.

1. An information processing apparatus comprising circuitry configured to:
receive an input of question data from a user via a terminal apparatus;
refer to a term dictionary database to perform a determination process to determine whether a term is included in the question data, the term dictionary database storing term information in which each of a plurality of terms is associated with information indicating a meaning of the term;
acquire, in a case that it is determined that the term is included in the question data, the information indicating the meaning of the term from the term dictionary database;
transmit a search request to a file database, the search request including the information indicating the meaning of the term included in the question data and the question data, the file database storing a file serving as an information source of answer data;
generate a prompt requesting generation of the answer data based on the file identified by searching the file database according to the search request;
output the prompt to a large-scale language model; and
output the answer data output by the large-scale language model based on the prompt to the terminal apparatus.

2. The information processing apparatus according to claim 1, wherein the circuitry is configured to:
receive a registration request for registering the file to be stored in the file database from another terminal apparatus different from the terminal apparatus;
generate another prompt requesting extraction of the term included in the file for which the registration request is received;
output the another prompt to the large-scale language model; and
refer to the term dictionary database to cause the file database to store the information indicating the meaning of the term extracted by the large-scale language model and the file in association with each other.

3. The information processing apparatus according to claim 1, wherein:
the determination process includes a first determination process, a second determination process, and a third determination process;
the first determination process is a process to search the question data using the term included in the term information as a search key and determine whether the term is included in the question data according to a search result;
the second determination process is a process to output another prompt to the large-scale language model, the another prompt requesting extraction of the term from the question data and including the term information stored in the term dictionary database, and determine whether the term is included in the question data according to a response output from the large-scale language model, and
the third determination process is a process to output the another prompt to the large-scale language model, acquire an extraction result provided by the large-scale language model, and determine whether the term is included in the question data according to a determination of whether the term information stored in the term dictionary database includes a term that matches the term included in the extraction result.

4. The information processing apparatus according to claim 1, wherein the circuitry is configured to:
receive, from another terminal apparatus different from the terminal apparatus, a request for generating the term information based on a file selected from among files stored in the file database;
generate another prompt requesting extraction of the term from the file;
output the another prompt to the large-scale language model; and
output, to the another terminal apparatus, the term output by the large-scale language model as a candidate of the term to be included in the term information.

5. The information processing apparatus according to claim 1, wherein
the term information includes the term, the information indicating the meaning of the term, and a category corresponding to the meaning of the term, and
the circuitry is configured to:
receive an input of the category corresponding to a content of a question indicated by the question data; and
transmit, to the file database, the search request including the information indicating the meaning of the term that is included in the term information stored in the term dictionary database and has the category matching the category corresponding to the content of the question.

6. The information processing apparatus according to claim 1, wherein
the term information includes the term, the information indicating the meaning of the term, and a category corresponding to the meaning of the term, and
the circuitry is configured to:
generate another prompt requesting inference of the category corresponding to a content of a question indicated by the question data;
transmit the another prompt to the large-scale language model; and
transmit, to the file database, the search request including the information indicating the meaning of the term that is included in the term information stored in the term dictionary database and has the category matching the category corresponding to the content of the question inferred by the large-scale language model.

7. The information processing apparatus according to claim 1, wherein
the term information includes the term, the information indicating the meaning of the term, and a category corresponding to the meaning of the term, and
the circuitry is configured to refer to the term information stored in the term dictionary database to transmit the search request including the information indicating the meaning of the term included in the question data and the category corresponding to the meaning of the term to the file database.

8. The information processing apparatus according to claim 1, wherein
the information indicating the meaning of the term is text data indicating a description of the term or a synonym having a meaning similar to the term.

9. The information processing apparatus according to claim 1, wherein the circuitry is configured to:
receive, from another terminal apparatus different from the terminal apparatus, a registration request for registering the file in the file database;
generate another prompt requesting extraction of the term included in the term dictionary database, from the file for which the registration request is received;
output the another prompt to the large-scale language model; and
refer to the term dictionary database to cause the database to store the information indicating the meaning of the term extracted by the large-scale language model and the file in association with each other.

10. An information processing apparatus comprising circuitry configured to:
transmit, to a terminal apparatus, screen information for displaying a workflow creation screen for creating a workflow according to an input from a user via the terminal apparatus;
create, according to the input to the workflow creation screen displayed on the terminal apparatus, the workflow defining contents of processes; and
execute the workflow,
the workflow including:
a process to receive an input of question data:
a process to refer to a term dictionary database to perform a determination process to determine whether a term is included in the question data, the term dictionary database storing term information in which the term is associated with information indicating a meaning of the term;
a process to acquire, in a case that it is determined that the term is included in the question data, the information indicating the meaning of the term;
a process to transmit a search request to a file database, the search request including the information indicating the meaning of the term included in the question data and the question data, the file database storing a file serving as an information source of answer data to the question data;
a process to generate a prompt requesting generation of the answer data based on the file identified by searching the file database according to the search request;
a process to output the prompt to a large-scale language model;
a process to acquire response data output by the large-scale language model based on the prompt; and
a process to output the response data as the answer data.

11. The information processing apparatus according to claim 10, wherein
the workflow creation screen includes:
a first display field in which a list of operation components corresponding to the processes that the information processing apparatus can execute is displayed; and
a second display field in which the operation components are arranged, and
the circuitry is configured to create the workflow based on the contents of the processes indicated by the operation components arranged in the second display field and an order in which the operation components are arranged.

12. An information processing method performed by an information processing apparatus, the method comprising:
receiving an input of question data;
referring to a term dictionary database to perform a determination process to determine whether a term is included in the question data, the term dictionary database storing term information in which each of a plurality of terms is associated with information indicating a meaning of the term;
acquiring, in a case that it is determined that the term is included in the question data, the information indicating the meaning of the term from the term dictionary database;
transmitting a search request to a file database, the search request including the information indicating the meaning of the term included in the question data and the question data, the file database storing a file serving as an information source of answer data;
generating a prompt requesting generation of the answer data based on the file identified by searching the file database according to the search request;
outputting the prompt to a large-scale language model; and
outputting the answer data output by the large-scale language model based on the prompt to a terminal apparatus.
